(19) United States
(12) Patent Application Publication
(10) Pub. No.: US 2003/0105826 A1
(43) Pub. Date: Jun. 5, 2003

(54) Communications system

(76) Inventor: Guy Mayraz, London (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 10/271,364

(22) Filed: Oct. 15, 2002

Related U.S. Application Data
(63) Continuation of application No. PCT/GB01/01672, filed on Apr. 12, 2001.

(30) Foreign Application Priority Data
Apr. 14, 2000 (GB) 0009339.3

(51) Int. Cl. G06F 15/16

(52) U.S. Cl. 709/206; 709/203

(57) ABSTRACT

A communications system including a server and a plurality of user apparatus, and methods of operating each of the same. The server stores user profiles corresponding to users' characteristics. Messages are allocated by matching target profiles with the user profiles. The user provides recipients of a message with an indication of the relative location of the recipient of the message to the sender of the message. Only one copy of the message need be stored by the server. Users can specify folder allocation rules. Data related to the sender of a message is attached with a message and can be varied on a message-by-message basis. A storage medium and a signal with processor-implementable instructions for the methods are also included.

### RELATED APPLICATIONS

This is a continuation under 35 U.S.C. 111(a) of PCT/GB01/01672, filed Apr. 12, 2001 and published in English as WO 01/80505 A1 on Oct. 25, 2001, which claimed priority from United Kingdom application No. 0009339.3 filed Apr. 14, 2000, which applications and publication are incorporated herein by reference.

### FIELD OF THE INVENTION

The present invention relates to a communications system for allocating and distributing messages between users of the communications system. The present invention is applicable to, but not limited to, the allocation and distribution of messages between users' computer apparatus via the Internet or a local area network or Intranet. The present invention also relates to a communications apparatus or server for controlling the allocation and distribution of messages.

### BACKGROUND

Many types of data network exist which distribute messages between users. One example is the Internet, over which messages can be conveyed in the form of e-mails. Other examples are local area networks (LANs) or Intranets over which messages can again be sent. The terminology “message” as used in this specification is to be understood to include any information content sent from one user to another, and thereby includes inter alia, either individually or in any combination, text, HTML, graphics, speech, other audio content, video and any other multimedia content.

Users can also use the Internet to access information by visiting websites, and if desired downloading information therefrom. Users can currently choose to visit websites of commercial companies or other organizations in which they are interested. Users can furthermore carry out searches, based for example on keywords, to locate websites/companies/organizations they have not previously been aware of. Users may be able to subscribe to an electronic mailing list of a desired company or organization to receive information on a regular basis.

Commercial companies or organizations can currently send unsolicited e-mail messages to potential customers/members by sending e-mails to addresses on a distribution list they have acquired by some means. The same message can be sent to a large number of different recipients.

A number of disadvantages exist with respect to the above-described current arrangements.

In the case of a user wishing to send a message, whether over the Internet to a private user, commercial company, or other organization or over a LAN or Intranet to for example other employees of the same company or company group, messages can only be sent to known recipients or at least known e-mail addresses.

In the case of a user wishing to arrange to receive messages from a commercial company or organization, the user needs to divulge his identity, or at least his e-mail address. Also, once placed on a mailing list, a user may not be able to have his address removed from that list.

In conventional systems, a recipient of a message is unable to determine the location of the sender of the message. If, however, the sender of the message specifies his address, then his anonymity or privacy can be compromised.

Also, in conventional e-mail message transmission systems, a separate copy of the same message needs to be stored at one or more servers for each recipient e-mail address.

In conventional e-mail systems it is known to allocate received messages to different incoming mail folders based on predetermined criteria related to some aspect of the message content or identity of the sender.

### SUMMARY OF THE INVENTION

In one aspect, the present invention enables a message sender to define different target profiles for different messages to enable the sender to target a specific message to a specific recipient audience desired by the sender.

In one aspect the present invention advantageously provides a communications system whereby a message sender can define for any message a target profile specific to that message and designed to specify expected characteristics of users that the message sender wishes to reach, and potential recipients can define respective user profiles defining their characteristics and interests wherein the communications system uses the target profiles and user profiles to allocate and allow sending of messages to suitable recipients without the need for either the identity of the message sender to be revealed to the recipient or the identity of the recipient to be revealed to the message sender. Users or types of messages can be divided into categories, allowing a user to specify a different user profile for each different category of message sender.

Another aspect of the present invention provides a convenient way in which a message recipient can determine useful information about the location of the message sender, without compromising the privacy or anonymity of either the message sender or the recipient.

Another aspect of the present invention provides a means for carrying out allocation and distribution of the same message to a number of different recipients in a manner, which alleviates the need to store a separate copy of the same message for each recipient.

Another aspect of the present invention provides a means to allocate received messages to folders on the basis of criteria, which advantageously relate to factors that extend beyond the conventional ones of message content or identity of the sender. For example, folder allocation can be based on criteria related to the user profile of the sender of a message and/or related to the target profile accompanying the message.

The present invention also provides a means for attaching or enclosing data related to the sender of a message that enables a user to conveniently vary the attached data on a message-by-message basis.

Another aspect of the present invention provides a communications system, comprising a server and a plurality of user apparatus, wherein the user apparatus comprise means for providing a respective user profile to the server, wherein each user profile specifies characteristics related to the corresponding user; the user apparatus comprise means for transmitting a target profile and a message content to the server, wherein the target profile specifies one or more criteria relating to characteristics that may be included in the user profiles; the server comprises means for comparing the target profile with the user profiles; and the server comprises means for allocating, according to the outcome of a comparing step performed by the comparing means, the message content to recipient users, for transmission to or retrieval by the recipient users.

Another aspect of the present invention provides a server, comprising:

means for receiving a plurality of user profiles, wherein each user profile specifies characteristics related to a corresponding user;

means for receiving a target profile and a message content, wherein the target profile specifies one or more criteria related to characteristics included in the user profiles;

means for comparing the target profile with the user profiles; and

means for allocating, according to the outcome of a comparing step performed by the comparing means, the message content to recipient users, for transmission to or retrieval by the recipient users.

Another aspect of the present invention provides a user apparatus for a communications system, comprising:

means for providing a user profile to a server, wherein the user profile specifies characteristics related to the corresponding user; and

means for receiving or retrieving a message content allocated to the user by a server of the communications system.

Another aspect of the present invention provides a user apparatus for a communications system, comprising:

means for transmitting a target profile and a message content to a server, wherein the target profile specifies one or more criteria related to characteristics included in the user profiles of other users.

Another aspect of the present invention provides a communications system or system, comprising a server and a plurality of user apparatus, wherein:

a first user apparatus of a first user comprises means for transmitting first location data, related to the location of the first user, to the server;

the server comprises means for converting the first location data into first coordinates;

a second user apparatus of a second user comprises means for transmitting second location data, related to the location of the second user, to the server;

the server comprises means for converting the second location data into second coordinates;

the first user apparatus comprises means for transmitting to the server a message content and preferably also an allocation specification, from which the server can ascertain to which other user or users the message content is to be allocated;

the server comprises means for allocating the message content to the second user, for transmission to or retrieval by the second user; and

the server comprises means for indicating to the second user the relative location of the first user to the second user.

Another aspect of the present invention provides a server for a communications system, comprising:

means for receiving, from a first user apparatus of a first user, first location data, related to the location of a first user;

means for converting the first location data into first coordinates;

means for receiving, from a second user apparatus of a second user, second location data, related to the location of the second user; means for converting the second location data into second coordinates;

means for receiving from the first user a message content and preferably also an allocation specification, from which the server can ascertain to which other user or users the message content is to be allocated; means for allocating the message content to the second user, for transmission to or retrieval by the second user; and means for indicating to the second user the reparative location of the first user to the second user.

Another aspect of the present invention provides a user apparatus for a communications system, comprising:

means for transmitting location data, related to the location of the user, to a server;

means for receiving or retrieving a message content sent from a further user to the server and allocated to the user; and

means for receiving or retrieving from the server an indication of the relative location of the further user to the user.

Another aspect of the present invention provides a server for a communications system, comprising:

means for receiving a plurality of message contents and allocation specifications from a plurality of users;

means for storing the plurality of message contents;

means for specifying a respective message ID for each message content;

means for determining from the allocation specification which users are to be allocated as recipient users to receive respective message contents;

means for forming for each recipient user a user's list of the message IDs of the message contents allocated to that recipient user; and

means for making the message content available for transmission to or retrieval by a recipient user on the basis of the message ID so that the server need only store one copy of the message content.

Another aspect of the present invention provides a communications system, comprising a server and a plurality of user apparatus, wherein:

a user apparatus of a first user comprises means for transmitting data, relating to the first user, to the server;

the server comprises means for storing the data relating to the first user;

a user apparatus of a second user comprises means for transmitting folder data to the server, wherein the folder data defines folder identities, a folder structure and folder allocation rules for allocating messages to folders;

the first user apparatus comprises means for transmitting to the server a message content and preferably also an allocation specification from which the server can ascertain to which other user or users the message content is to be allocated;

the server comprises means for allocating the message content to the second user;

the server comprises means for analysing the folder allocation rules with respect to the data relating to the first user and/or with respect to the allocation specification; and

the server comprises means for specifying, responsive to an analysis performed by the analysing means, one or more folder identities of the second user for transmission to or retrieval by the second user of the message content directly into the one or more specified folder identities.

Another aspect of the present invention provides a server for a communications system, comprising:

means for receiving, from a user apparatus of a first user, data relating to the first user;

means for storing the data relating to the first user;

means for receiving, from a user apparatus of a second user, folder data, wherein the folder data defines folder identities, a folder structure and folder allocation rules for allocating messages to folders;

means for receiving from the first user a message content and preferably also an allocation specification from which the server can ascertain to which other user or users the message content is to be allocated;

means for allocating the message content to the second user;

means for analysing the folder allocation rules of the second user with respect to the data relating to the first user and/or with respect to the allocation specification; and

means for specifying, responsive to an analysis performed by the analysing means, one or more folder identities of the second user for transmission to or retrieval by the second user of the message content directly into the one or more specified folder identities.

Another aspect of the present invention provides a user apparatus for a user in a communications system comprising:

means for providing, to a server, folder data, wherein the folder data defines folder identities, a folder structure and folder allocation rules for allocating messages to folders;

and means for receiving or retrieving from the server a message content directly into one or more folder identities.

Another aspect of the present invention provides a communications system, comprising a server and a plurality of user apparatus, wherein:

a first user apparatus of a first user comprises means for providing a user profile to the server, wherein the user profile specifies characteristics related to the first user;

the first user apparatus comprises means for transmitting to the server a message content, preferably also an allocation specification from which the server can ascertain to which other user or users the message content is to be allocated, and an indication of a selection of the characteristics specified in the user profile;

the server comprises means for allocating the message content to a second user, for transmission to or retrieval by the second user; and

the server comprises means for indicating to the second user the characteristics contained in the first user's selection of characteristics.

Another aspect of the present invention provides a server for a communications system comprising:

means for receiving from a first user apparatus of a first user a user profile, wherein the user profile specifies characteristics related to the first user;

means for receiving from the first user apparatus a message content, preferably also an allocation specification from which the server can ascertain to which other user or users the message content is to be allocated, and an indication of a selection of the characteristics specified in the user profile;

means for allocating the message content to the second user, for transmission to retrieval by the second user; and

means for indicating to the second user the characteristics contained in the first user's selection of characteristics.

Another aspect of the present invention provides a user apparatus for a user for use in a communications system comprising:

means for providing a user profile to a server, wherein the user profile specifies characteristics related to the user; and

means for transmitting to the user a message content, preferably also an allocation specification from which the server can ascertain to which other user or users the message content is to be allocated, and an indication of a selection of the characteristics specified in the user profile.

Another aspect of the present invention provides any combination of the above described aspects of the present invention.

Another aspect of the present invention provides a method for operating a communications system of the type described in any of the above aspects of the present invention.

Another aspect of the present invention provides a method performed by a server of the type described in any of the above aspects of the present invention.

Another aspect of the present invention provides a method performed by a user apparatus in a communications system, wherein the user apparatus is of the type described in any of the above aspects of the present invention.

Embodiments of the present invention will now be described by way of example only, with reference to the accompanying drawings, in which:

### BRIEF DESCRIPTION OF THE DRAWINGS

FIG. 1 is a schematic illustration of a communications system of an embodiment of the present invention;

FIG. 2 is a schematic illustration of a communications system of an embodiment of the invention;

FIG. 3 schematically illustrates functionally a computer apparatus of an embodiment of the invention;

FIG. 4 schematically illustrates a data storage arrangement of an embodiment of the invention;

FIG. 5a schematically illustrates a received message employed in an embodiment of the invention;

FIG. 5b schematically illustrates a processed message employed in an embodiment of the invention;

FIG. 6 schematically illustrates a user profile data arrangement of an embodiment of the invention;

FIG. 7 schematically illustrates an arrangement of data specifying a user's personal details employed in an embodiment of the invention;

FIG. 8 schematically illustrates an arrangement of data specifying a user's interests employed in an embodiment of the invention;

FIG. 9 schematically illustrates a location profile employed in an embodiment of the invention;

FIG. 10 schematically illustrates a place name hierarchy employed in an embodiment of the invention;

FIG. 11 schematically illustrates an area hierarchy structure employed in an embodiment of the invention;

FIG. 12 schematically illustrates an arrangement of data specifying a user's default sender data employed in an embodiment of the invention;

FIGS. 13a and 13b schematically illustrate respective target profiles employed in embodiments of the invention;

FIG. 14 schematically illustrates a folder structure employed in an embodiment of the invention;

FIG. 15 schematically illustrates a folder allocation rule employed in an embodiment of the invention;

FIG. 16 schematically illustrates an organization's target profile employed in an embodiment of the invention;

FIG. 17 schematically illustrates a user's list of messages employed in an embodiment of the invention;

FIG. 18 schematically illustrates an arrangement of data specifying a user's sender data employed in an embodiment of the invention;

FIG. 19 schematically illustrates a database structure of an embodiment of the invention;

FIG. 20 shows the processing steps performed by a server in an embodiment of the invention;

FIG. 21 schematically illustrates the operation of a communications system in an embodiment of the invention;

FIG. 22 schematically illustrates the provision of relative location information in an embodiment of the invention; and

FIGS. 23 to 27 show screens that may be displayed to a user to enable the user to send a message.

### DETAILED DESCRIPTION

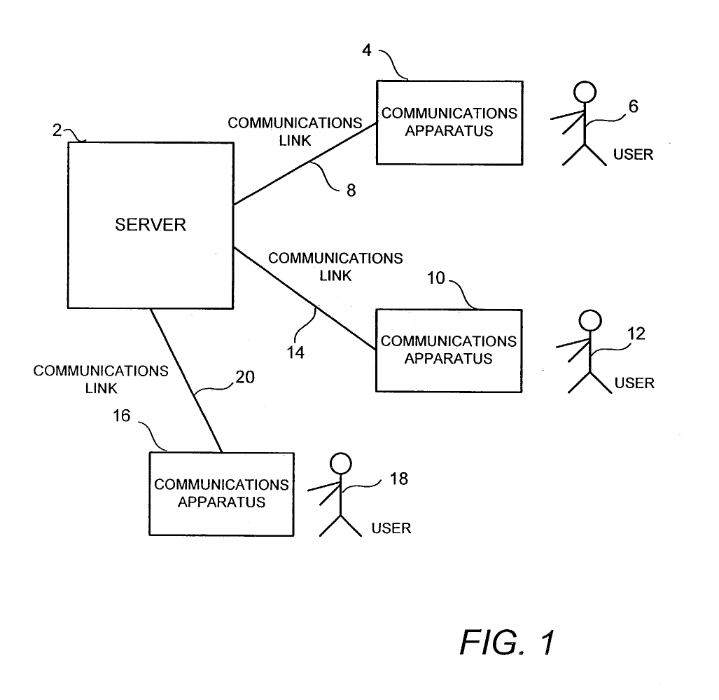

FIG. 1 schematically illustrates a communications system according to a first embodiment. A server 2 is coupled by means of communications link 8 to communications apparatus 4, which is used by a user 6. Server 2 is further coupled by communications link 14 to communications apparatus 10, which is used by a further user 12. Server 2 is also connected by communications link 20 to communications apparatus 16, which is used by yet another user 18. Although only three communications apparatus with respective users are shown in FIG. 1, in practice many more may be connected to server 2.

In operation, server 2 receives messages from one or more communications apparatus 4, 10, 16, and then determines which users each received message should be allocated to. The server then either distributes the messages to the allocated recipient users, or stores the messages and allocation decisions such that allocated recipient users can later retrieve the messages. The communications apparatus 4, 10, 20 correspondingly send original messages from their respective users to server 2, along with additional information termed target profiles that server 2 uses to decide the allocation of messages. Communications apparatus 4, 10, 16 also serves to receive or retrieve messages that have been allocated to its respective user.

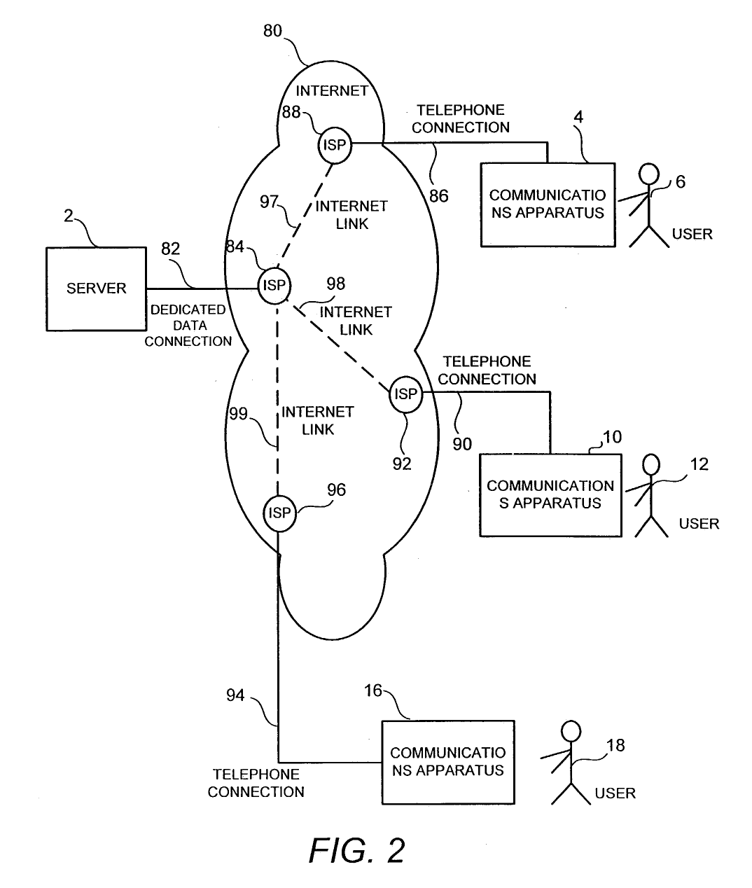

One way of implementing the communications links 8, 14, 20 will now be described with reference to FIG. 2, which shows the server and each of the communications apparatus interconnected via the Internet 80. More particularly server 2 is coupled to an Internet service provider 84 by any suitable connection, in the present example a dedicated data connection 82, communications apparatus 4 is coupled by any suitable connection, in the present example telephone connection 86, to an Internet service provider 88, communications apparatus 10 is coupled by any suitable connection, in the present example telephone connection 90 to an Internet service provider 92, and communications apparatus 16 is coupled by any suitable connection, in the present example telephone connection 94 to an Internet service provider 96. The respective connections between server 2 and each communications apparatus 4, 10, 16 is then completed in conventional fashion by Internet links 97, 98 and 99 respectively.

The users can be divided into different categories. In the present embodiment there are three basic categories, namely private users, commercial companies and non-profit organizations. Further categories can be formed from users within more than one of these three basic categories. Also the users' may be individuals or employees within a single company or group of companies. In this case the communication links may be provided by a local area network (LAN) or an Intranet specific to that company or group of companies.

One way of operating the arrangement shown is for the communications apparatus of the user to be configured as a web browser, in order to access server 2 which carries out all message processing and storing. However, in the present embodiment, each of communications apparatus 4, 10 and 16 are specifically configured to carry out certain functions specifically related to the present embodiment, as will be described later below. In this sense their operation is analogous to that of a desktop client application.

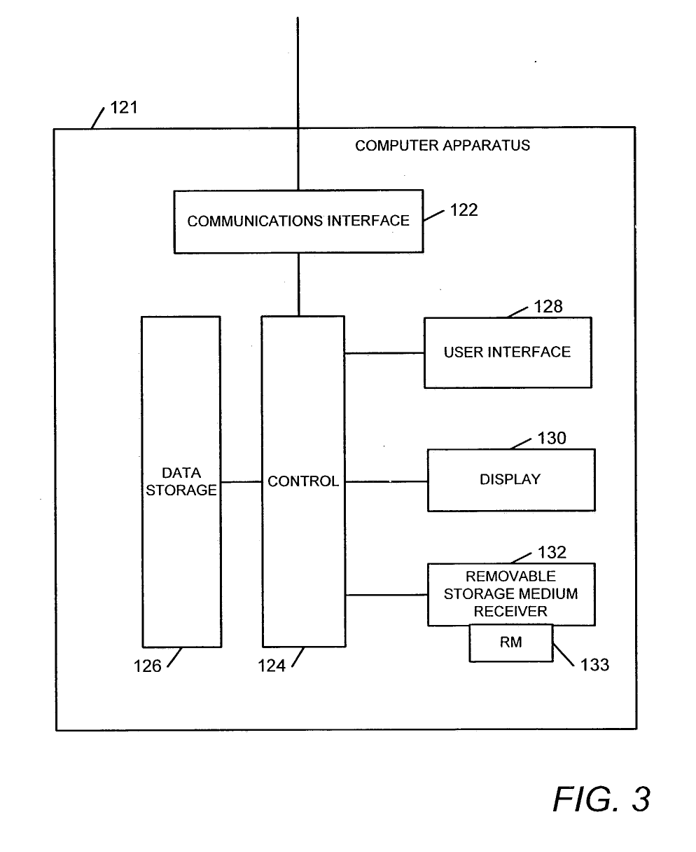

In the present embodiment, server 2, communications apparatus 4, communications apparatus 10 and communications apparatus 16 are each implemented in the form of respective computer apparatus 121 of the type illustrated schematically in FIG. 3. Computer apparatus 121 comprises a communications interface 122, for example a MODEM, coupled to a central processing unit or control 124, which consists of one or a number of processors. Control 124 is coupled to data storage 126, which for example is made up of a hard disk drive and ROM and/or RAM. Control 124 is also coupled to user interface 128, comprising for example a keyboard, computer mouse or other pointing device, microphone and video camera. Control 124 is also coupled to display 130. Control 124 is also coupled to a removable storage medium receiver 132, for example, a CD ROM drive. The computer apparatus 121 is configured to form the server 2 or a communications apparatus 4, 10, 16 by computer program instructions and possibly also data. These may be supplied by any one or any combination of the following: as a signal via communications interface 122, on a removable medium (RM) 133, for example a CD ROM, placed in removable storage medium receiver 132, and input via the user interface 128.

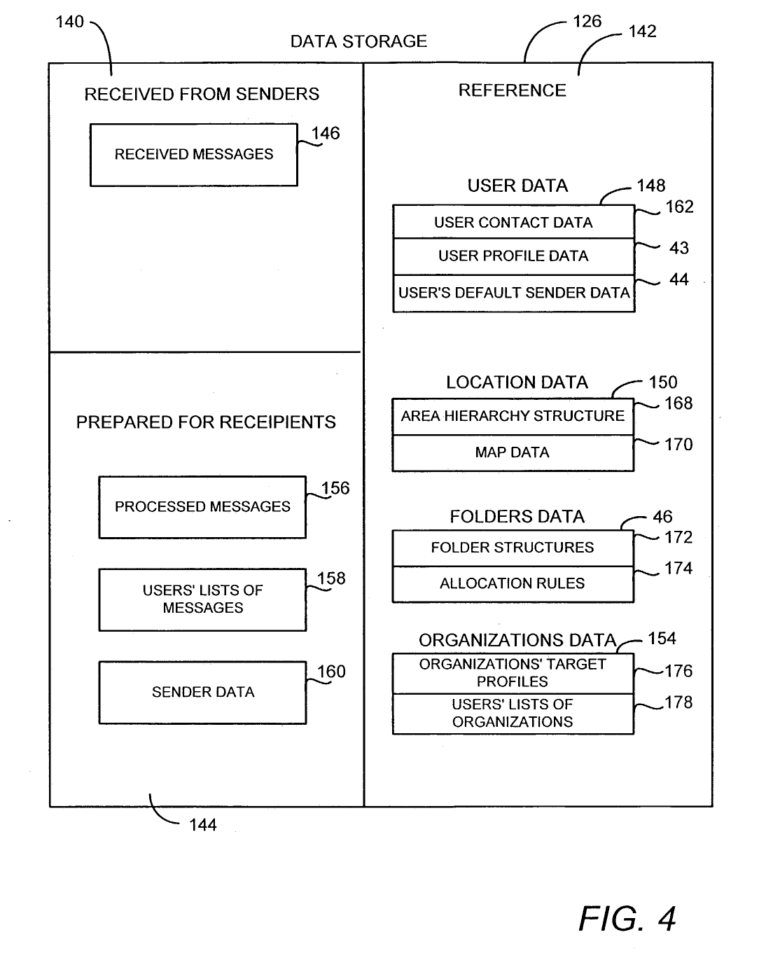

Examples of the types of data stored, and the form in which this data is stored in data storage 126 of server 2 will now be described with reference to FIGS. 4 to 19.

The different types of data are grouped in the schematic illustration of FIG. 4 according to the broad function of each type of data. The data can be broadly divided into three sections. The first is termed reference data 142, and this contains various types of data held at any particular time in data storage 126 for use by control 124 when incoming messages are received. The second category contains messages being received from users. When an incoming message has been received, but has not yet been processed with respect to reference data 142, or is still undergoing processing with respect to reference data 142, it is stored in received messages data 146. Data that is produced as the outcome of processing the received messages 146 with respect to reference data 142 is stored in the third section of data, namely data 144 prepared for recipients 144.

Reference data 142 can be classified into four broad types of data, namely user data 148, location data 150, folders data 46 and organizations data 154. User data 148 is further classified into user contact data 162, user profile data 42 and users' default sender data 44. Location data 150 is further classified into area hierarchy structure 168 and map data 170. Folders data 46 is further classified into folders structure 172 and allocation rules 174. Organizations data 154 is further classified into organizations' target profiles 176 and users' lists of organizations 178.

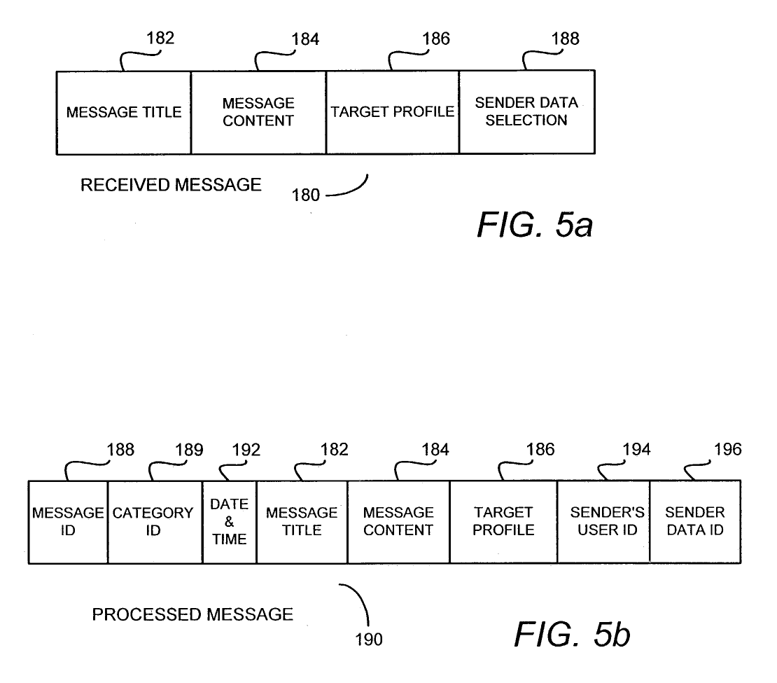

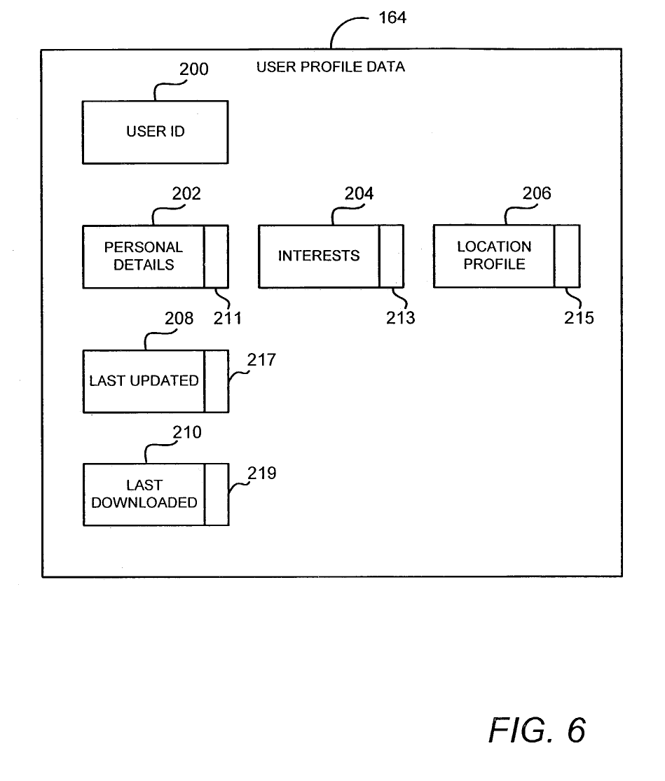

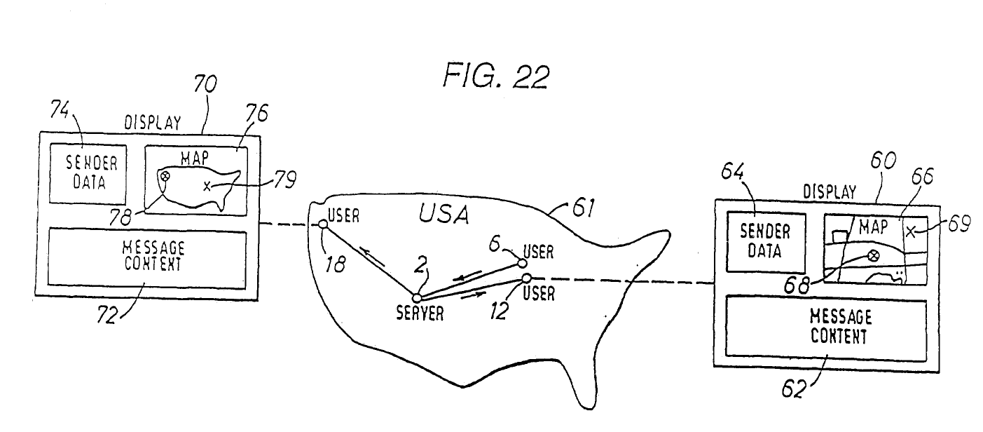

The data 144 prepared for recipients contains three broad types of data, namely processed messages 156, users' lists of messages 158 and sender data 160. Each of the above mentioned types of data will now be described in more detail with reference to FIGS. 5 to 18. Thereafter one way of implementing a database structure for the information will be described with reference to FIG. 20.

FIG. 5a is a schematic illustration of a received message 180 which is made up of a message title 182, the content of the message 184, a target profile 186 and a sender data selection 188. The message title is provided by the creator and sender of the message in the same way as with a conventional e-mail message. Message content 184 contains data representing the information content being sent, and this is stored in any suitable conventional fashion, similar also to conventional e-mail arrangements. Message content 184 can be, inter alia, either individually or in any combination, text, HTML, graphics, speech, other audio content, video or any other multimedia content. The target profile 186 comprises a selection of characteristics that the sender of the message requires allocated recipients to possess. The chosen characteristics are selected from characteristics that are available to users for inclusion in their user profile data, and therefore further details of the target profile 186 are most readily explained later below after details of the user profile data 43 have been described. Similarly, the sender data selection 188 consists of a selection that the sender of the message makes from the details in his own user profile data, and therefore further details of sender data selection 188 will also be given later below after the user profile data 43 has been described.

Each received message 180 is processed by server 2 to provide a processed message 190, as shown in FIG. 5b, which is stored in the processed messages section 156. The processed message contains the same message title 182, message content 184 and target profile 186 as were contained in the received message, plus various further items of data related to the identity of the sender of the message and the context of the message. In particular, server 2 adds message ID 188, which is in the form of a unique identification for that message. Also added is category ID 191, which identifies the category of the user, e.g. private user, commercial company or non-profit organization. Server 2 also adds date and time information 192 indicating when the message was received. Also added is the sender's user ID 194, which indicates the unique identity of the user who was the sender of the message. This latter information can be made use of in a number of ways, for example, in identifying which user any replies should be forwarded to. Also added in the processed message is sender data ID 196, which is added in the present embodiment to provide a cross-reference to the sender data selection 188 in the received message 180. The sender data ID 196 represents an identity which server 2 can use to cross reference with a given selection of data that the sender wishes to be made available to recipients along with the message content. In the present embodiment, such cross-reference data is stored in the sender data section 160 of data storage 126.

Details of the contents of user data 148 will now be described. As mentioned above, user data 148 can be divided into three types, namely user content data 162, user profile data 143 and users' default sender data 44. User contact data 162 contains data specific to the user which is however never included in a user's profile when matching with target profiles. The separate items of data relating to a given user are linked in data storage 126 by means of a unique user ID. In the present embodiment, the user contact data 162 consists of the user ID referenced to the name and address of the user.

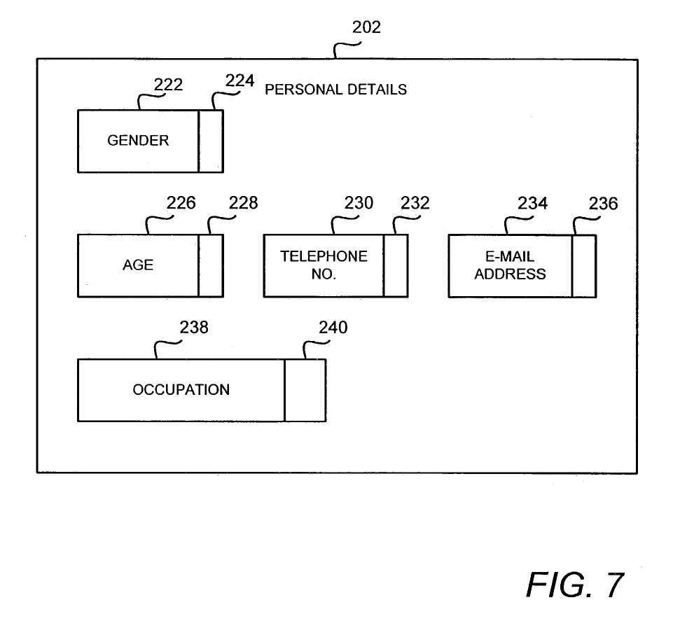

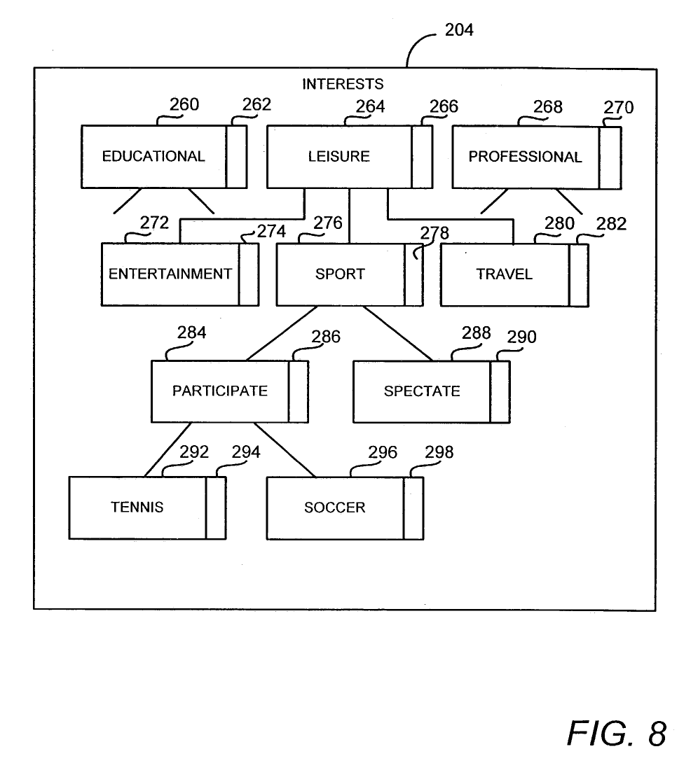

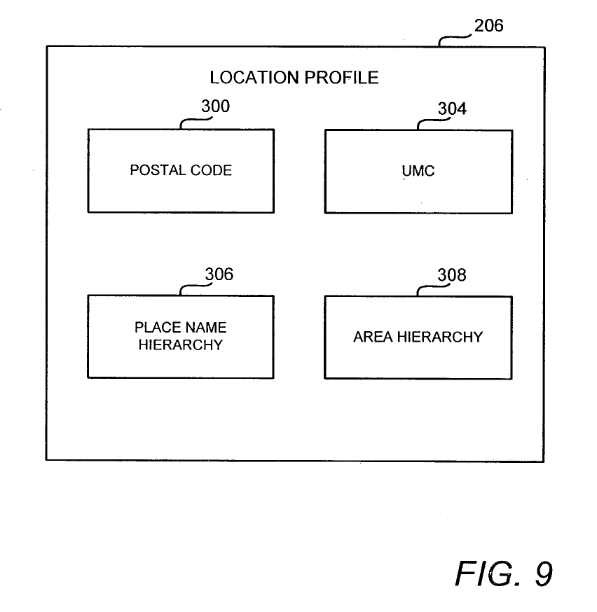

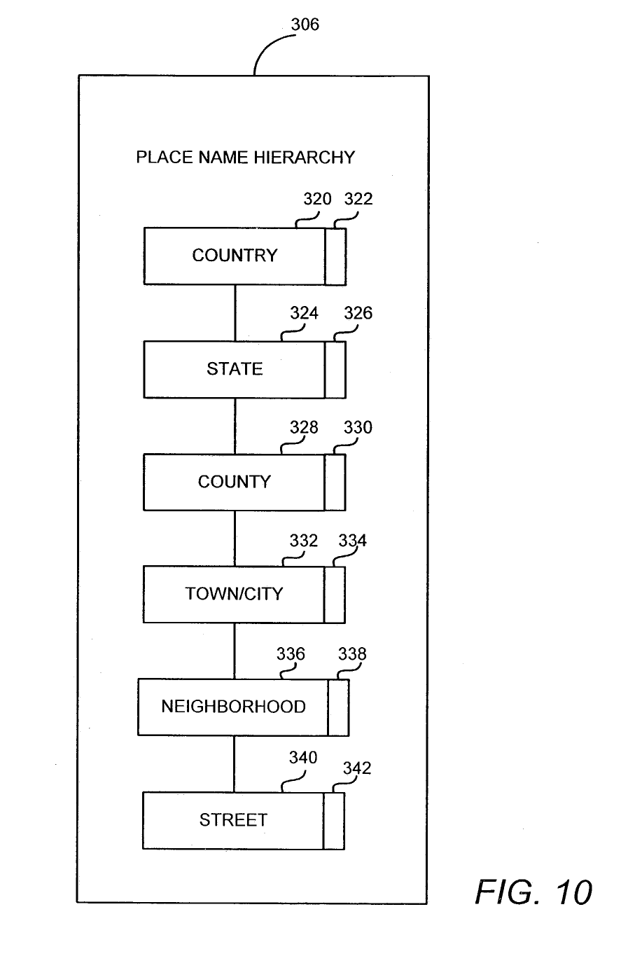

Other data characterising the user is contained in user profile data 43, as shown in FIG. 6. User profile data 43 contains the user ID 200, personal details 202, which will be described in more detail with reference to FIG. 7, interests 204 which will be described in more detail with reference to FIG. 8, and a location profile 206 which will be described in more detail with reference to FIGS. 9 to 11. User profile data 43 also includes data 208 specifying when the user last updated his profile, and data 210 defining when the user last downloaded messages allocated to him as a recipient.

Each of the data types in user profile data 43 have attached thereto a profile detail identity, which is used to tag which items of the user profile data are to be included as sender data when a user sends a message. In the case of personal details data 202, interest data 204 and location profile data 206, these represent hierarchies or tree structures of options of data, and hence if the respective profile detail ID fields 211, 213 and 215 are selected, then all the profile data contained in the tree structures of these fields will be included as part of the sender data. In the case of the sender detail ID 217 attached to the last updated data 208, and sender detail ID 219 attached to the last downloaded data 210, these simply determine whether the respective individual items of information are included in sender data.

The above description assumes that the main application of the system is for leisure activity. However, as will be made clear below, the system has applications in the workplace. The user profiles and the target profiles that can be designed by the sender of a message will be dependent upon the particular application of the system. For example available categories or profile elements may include any one or more of: personal interests, professional interests, location, current location, office department, project membership, group membership, qualifications, skills, job function, job title/position, gender, age, years services.

FIG. 7 shows by way of example a selection of data fields specifying personal details that a user has chosen to be included in his user profile data. Included are specification 222 of the user's gender with corresponding profile detail ID 224, specification 226 of the user's age with corresponding profile detail ID 228, specification 230 of the user's telephone number with corresponding profile detail ID 232, specification 234 of the user's e-mail address, with corresponding profile detail 236, and specification 238 of the user's occupation, with corresponding profile detail ID 240. In the event that a user does not wish to include all these personal details for inclusion in his sender data, by specification of profile detail ID 211, then he is instead able to select a desired combination of the individual profile detail IDs shown in FIG. 7.

FIG. 8 schematically illustrates fields of data that a user has specified in his user profile data for the purpose of indicating subjects he is interested in. The various choices are arranged in a tree structure form. Hence by selecting different choices at different levels within the tree structure, appropriate refinement of profile matching with target profiles can be carried out, and similarly appropriate choice of hierarchy level of specified sender data to be attached with the message can be achieved. In the present example the user has specified interest in the area of educational matters 260, which has corresponding profile detail ID 262, the area of leisure 264, with corresponding profile detail ID 266, and the area of professional matters 268, with corresponding profile detail ID 270. In the present example the user has specified further detailed choices under each of these three fields, but only those selections made in the field of leisure are shown and will be described further. The user has indicated an interest in the area of entertainment 272, which has corresponding profile detail ID 274. The user has however specified no more detailed indications in that area. Similarly the user has indicated a general interest in travel 280 with corresponding profile detail ID 282 but again has made no further detailed specification in that area. The user has a third area of specification of interest derived under leisure, namely sport 276 with corresponding profile detail ID 278. In the case of sport, the user has made a yet more detailed selection, indicating an interest in participating in sport 284, with corresponding profile detail ID 286, and also spectating 288 at sport with corresponding profile detail ID 290. Yet further the user in the present example has gone on to specify that in terms of participating in sport he particularly has an interest in participating in tennis 292 with corresponding profile detail ID 294, and soccer 296 with corresponding profile detail ID 298. It can be appreciated from this example how each user is able to tune his profile data to his own specific interests, in a way that will render later matching between target profiles of messages with user profile data very precise in terms of directing messages to those users who are likely to wish to receive particular messages.

Referring now to FIG. 9, location profile 206 of user profile data 43 includes data specifying the postal code 300 of the user. Also included are universal map coordinates (UMC) 304 which correspond to the respective user's address and are determined by any appropriate conventional means.

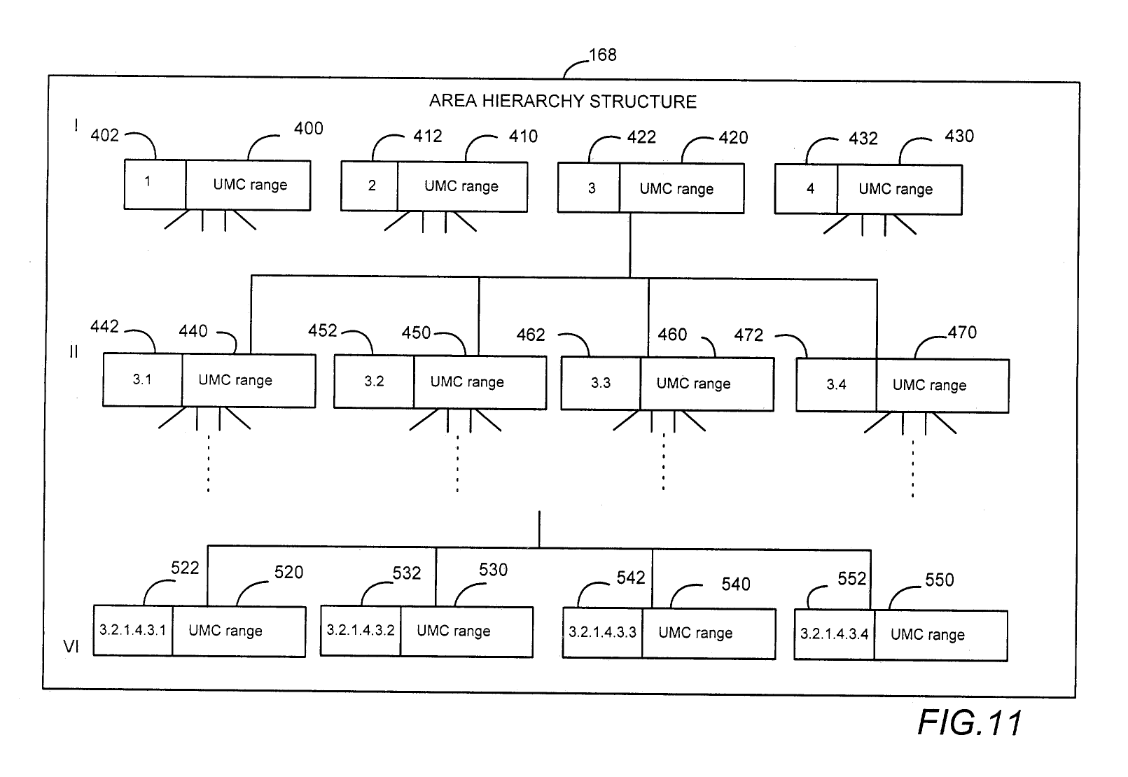

Also included is data defining a hierarchy of place names 306, and data specifying an area hierarchy 308. From the postal code data 300 of a given user, server 2 is able to determine a hierarchical series of place names which fit the user's address. The data structure of the place name hierarchy 306 is shown in FIG. 10 for a user resident in the USA. Place names are specified for country 320, state 324, county 328, town/city 332, neighbourhood 336, and street 340. Each of these types of data has a respective profile detail ID 322, 326, 330, 334, 338 and 342. By including such a place name hierarchy in a user's profile, target profiles can be specified by message senders at an appropriate hierarchy level depending upon the purpose of the message. Matching between the target profile and the user's profile can then take place at that hierarchy level. For example, a private user wishing to contact potential new golf partners would probably define his target profile in terms of either neighbourhood 336 or at most town/city 332. On the other hand, a large commercial company may wish to target outgoing messages to users specified by county 328 or state 324. Similarly, by virtue of each level of the hierarchy having its own profile detail ID, a user can determine what degree of detail of his own location he wishes to reveal to recipients of his message. In the present embodiment, because normally relative location information is anyway included with each message by means of the earlier described map indications which by default select an appropriate scale, this is somewhat redundant. However, in other embodiments where such map location information is only optionally sent by a message sender, or alternatively is not included at all, the significance of the ability to chose between different profile detail IDs with respect to location when specifying sender data becomes more significant. Moreover, as is a general advantage of many embodiments of the present invention, the ability to specify a particular hierarchical level of profile detail ID preserves the message senders control of his anonymity and privacy, whilst providing more information than is available in conventional e-mail.

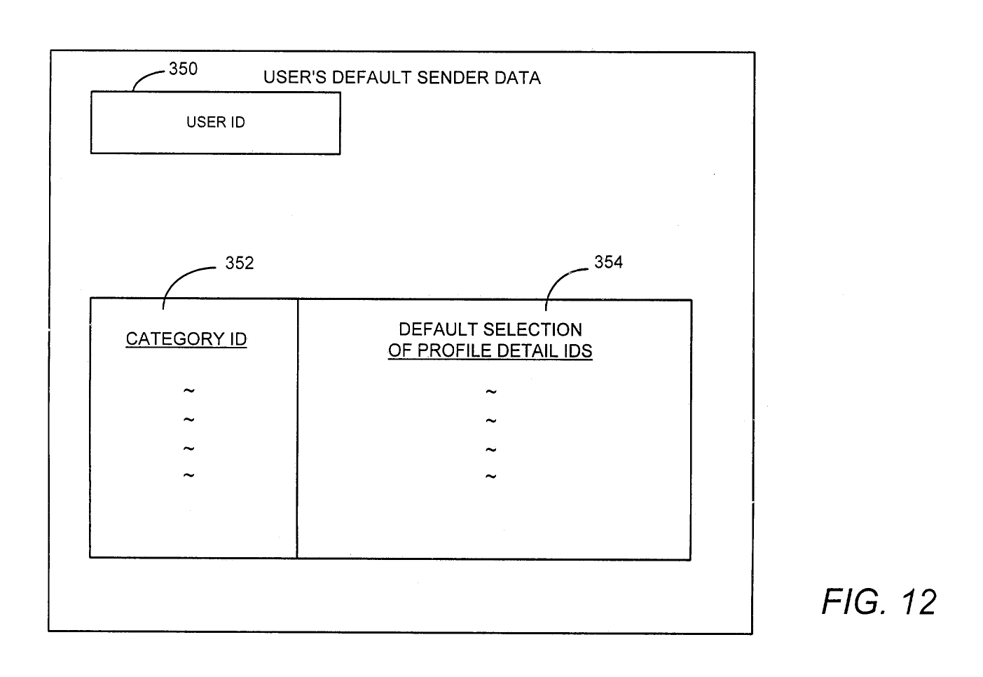

In the present embodiment an alternative hierarchical data structure for defining location is also included in the user's profile data and is specifiable by a single identity which is held as area hierarchy data 308. The specification for each user corresponds to a common area hierarchy structure 168. Area hierarchy structure 168 is a data structure common to all users, and is shown in FIG. 6 as part of location data 150. It is however appropriate to describe it in detail at this stage, in order to further understand the area hierarchy data 308 contained in location profile 206. Area hierarchy structure 168 is shown schematically in FIG. 11, and consists of the world defined by division into areas of decreasing size. At the first hierarchical level I, the world is divided into four areas, preferably four even sized rectangles or squares with respect to a planar representation of the world. Each area is defined by a UMC range e.g. a rectangle specified by coordinates in the form (x_{1.} x_{.} x₂, y_{1.} y_{.} y₂), such that the first area is defined by UMC range 400 and is labelled with a unique identity field 402, the second area is defined by UMC range 410 with a unique identity field 412, the third area is defined by UMC range 420 with unique identity field 422 and the fourth area by UMC range 430 with unique identity field 432. In the second hierarchy level II each area of the first hierarchy level is itself divided into four areas, although in FIG. 11 only the four UMC ranges 440, 450, 460 and 470 (with corresponding unique identity fields 442, 452, 462, 472) specifying the four sub-divisions of the third area of the first hierarchy level I are shown. Each further hierarchy level consists of further sub-divisions, down to hierarchy level VI, of which one set of four sub-divisions is shown by way of example in FIG. 11, namely UMC ranges 520, 530, 540 and 550 with corresponding unique identity fields 522, 532, 542 and 552. One way of implementing the unique identity fields has been shown in FIG. 11, in which for example, the value 3.2.1.4.3.2 of the unique identity field 532 indicates that this area was derived from the third area of hierarchy I via the second sub-division of that area, and so on.

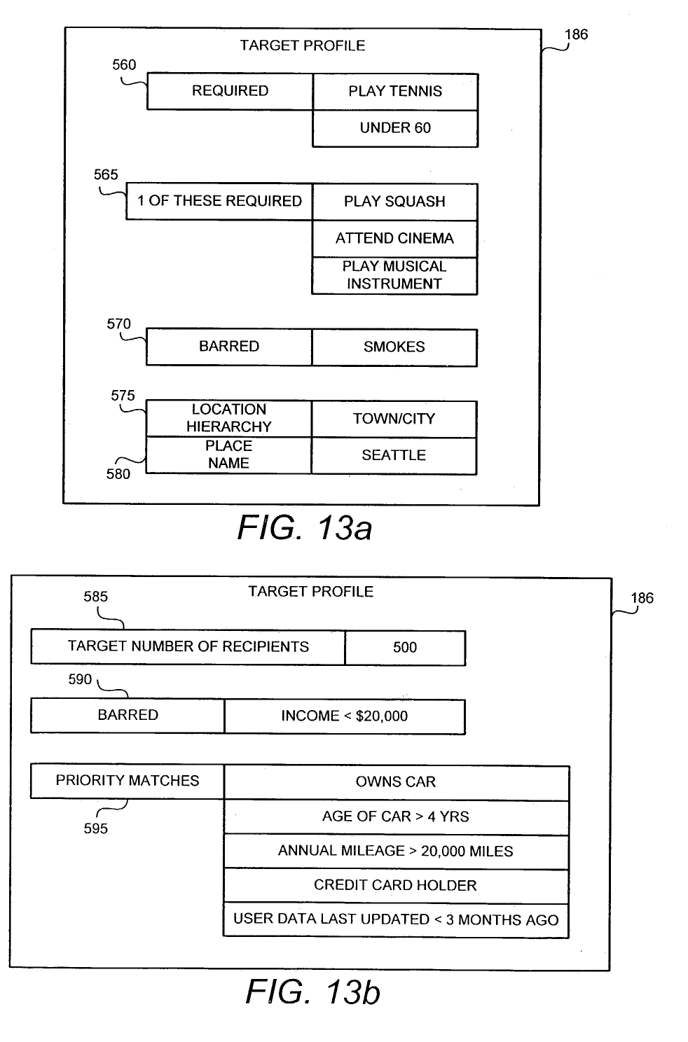

User data 148 further contains user's default sender data 44, which is represented schematically in FIG. 12. Referenced to each user by a user ID 350, a default selection 354 of profile detail IDs are specified by each user or by a system standard default specification, specific to the particular category ID 352 defining the category of user of the message being sent to which the default selection of profile data IDs is to apply.

Returning now to target profile 186 as contained in received message 180 and processed message 190, this can now be explained in the light of the above description of the user profile data 43. A sender of a message is able to specify criteria relating to one or more details within one or more of the sections of data available for specification in users profiles. For example, considering only those types of data shown in the specific example of user profile data 43, details from any one or more of personal details 202, interest 204, location profile 206, last updated data 208 and last downloaded data 210 might be selected. Moreover, in the case of types of data arranged in hierarchical levels, the sender of a message is able to choose details from one or more levels within such hierarchical level. For example considering just the case of the data explained already with respect to FIG. 8, a message sender can choose to specify criteria related to any particular levels of detail within such hierarchical structure.

Moreover, a sender of a message can specify different types of criteria, e.g. a criteria that a specific profile detail is required in a user's profile, or a disjointed criteria that one (or any other specified number) from a list of possible profile details is required to have been specified in a user's profile. A further form of criteria is to specify a profile detail that is barred, i.e. if found in a user's profile excludes the user from being allocated to receive that message.

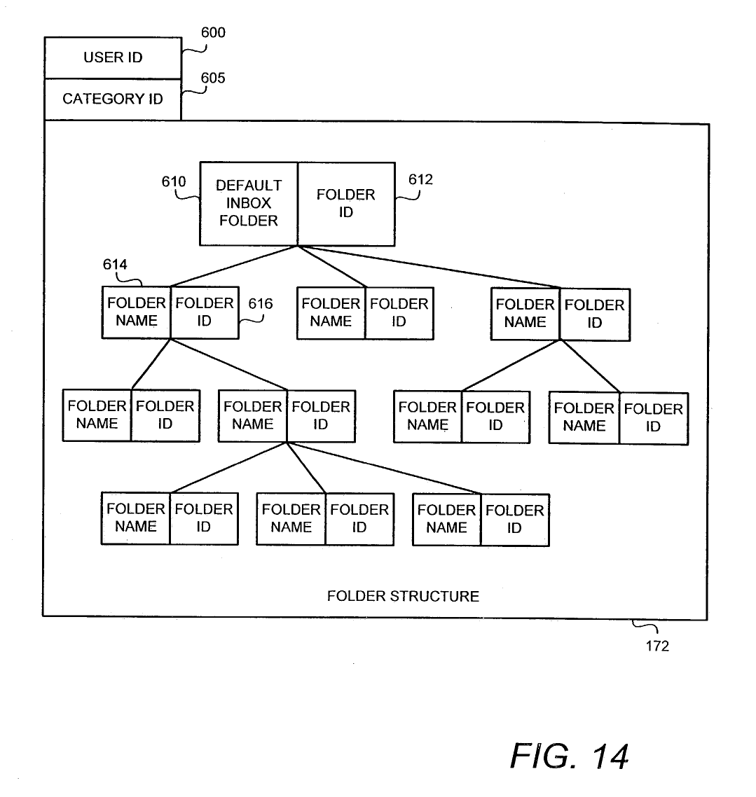

One example of a target profile is shown in FIG. 13a. This example represents a target profile defined by a private user sending messages to other private users, who is interested in contacting people with similar leisure interests who live in his vicinity. The target profile contains a required criteria 560, which requires a user's profile to specify the playing of tennis and that the user's age is under 60 years old. The target profile contains an example 565 of a disjointed property requirement i.e. that one of three particular profile details are required, namely playing of squash, attending cinema and playing a musical instrument. A target profile also contains an example 570 of a barred property, in the present case users who are smokers according to their profiles are excluded. Location details of potential recipient users are included in the target profile also. This includes a specification 575 of the level of location hierarchy, which in the present case has been specified as town/city, and specification of the place name 580, which in the present example is Seattle. It is noted that an alternative specification of location in such a target profile could be in terms of distance from the message sender's location. Further details of both types of location specification will be given later below.

Another approach is to specify a required number of receivers of a message. In this approach, a list of profile details is included, in an order of priority. User profiles are first compared with the first profile detail that is listed as required and the number of recipients of the message that would provide is compared with the target number of recipients. If the number is greater than the target number of recipients, then those users already located have their profiles compared with the second priority profile details in the specification, and so on until the number of recipients is narrowed down to a number equal to or less than the target number specified by the message sender. A preferred option is to have a more complicated algorithm, for example one which on working through the priority list compares the number of recipients determined after the last criteria that still gives more recipients over the target number compared to the number of recipients found for the first criteria under the target number, and then selects between those two possibilities according to which is closer to the target number.

An example of a target profile specifying a target number of recipients is shown in FIG. 13b, where the target number of recipients 585 is shown with the value 500. This example relates to a sender in the second category, i.e. commercial companies, who wishes to target potential customers for a particular car sales offer. This target profile additionally contains a barred criteria 590, which in this case shows that users with an income less than $20,000 per annum are to be excluded from the matching procedure. The priority list of matching requirements 595 is also shown, and consists in the present case of specifying first users whose user profiles indicate they own a car, followed by the detail of an age of car being later than four years, followed by the annual mileage being greater than 20,000 miles, followed by the user being a credit card holder and followed by the date of the user's last update being less than three months beforehand.

Turning now to location data 150, this contains area hierarchy structure 168, which was described earlier above, and map data 170, which will now be described.

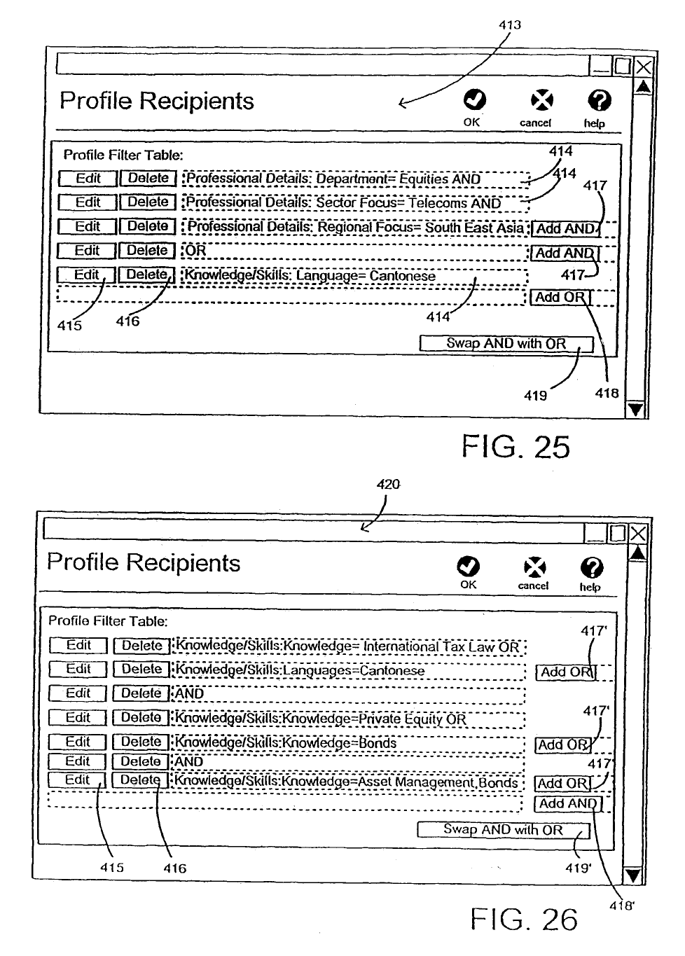

A series of maps of different scales are created for each user. The maps are such that the location of the user is in the centre of each map, except for situations such as when a whole country is displayed. Depending on the scale of the map, some maps may be shared between users. The maps are calibrated with universal map coordinates. The correspondence between each user, map scale and map image is defined in any appropriate manner. Provision of the map data 170 to users will be described later below with reference to FIG. 22.

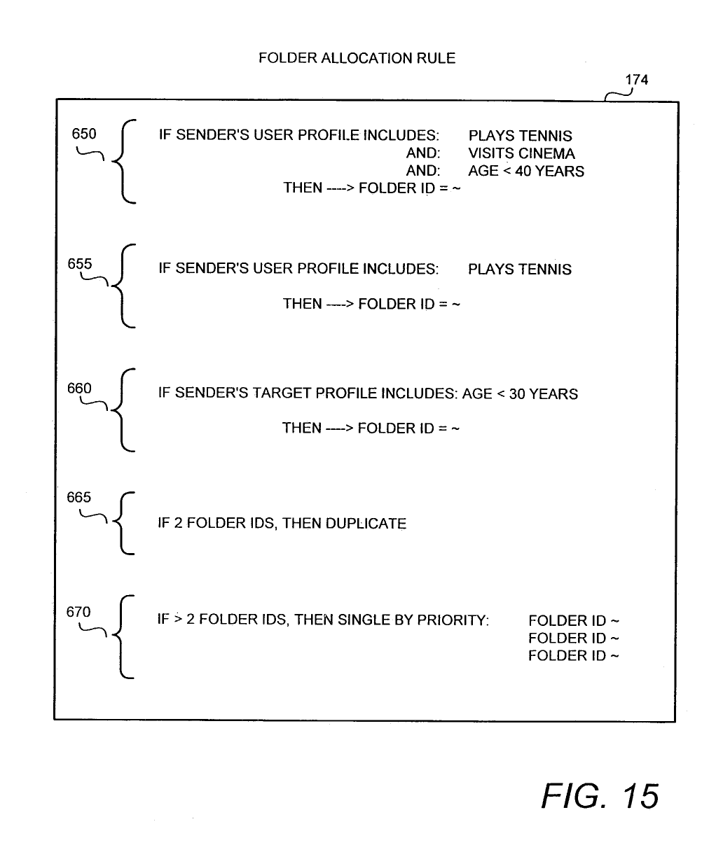

The data defining folder structures 172 will now be described with reference to FIG. 14, which schematically illustrates a folder structure 172 for a given user ID 600 and category ID 605. In the present example the folder structure is in the form of a tree structure. Each folder is specified by a folder name 614 and a folder ID 616. The tree structure is headed by a default inbox folder 610, which also has a folder ID 612. The data also needs to specify a structure of the tree in any appropriate manner. In the present embodiment, both the folder names and the folder structure are specified by the particular user. The user is able to specify different numbers of folders at any branch level of the tree structure, and is able to define different numbers of branch levels along different paths through the tree structure, as shown in FIG. 14. The user is able to specify the particular folders in which messages are to be directed or allocated, according to folder allocation rules which will be described below. Correspondence between folder names and folder IDs, as well as the way in which these features are presented to a user, can be implemented in any appropriate manner.

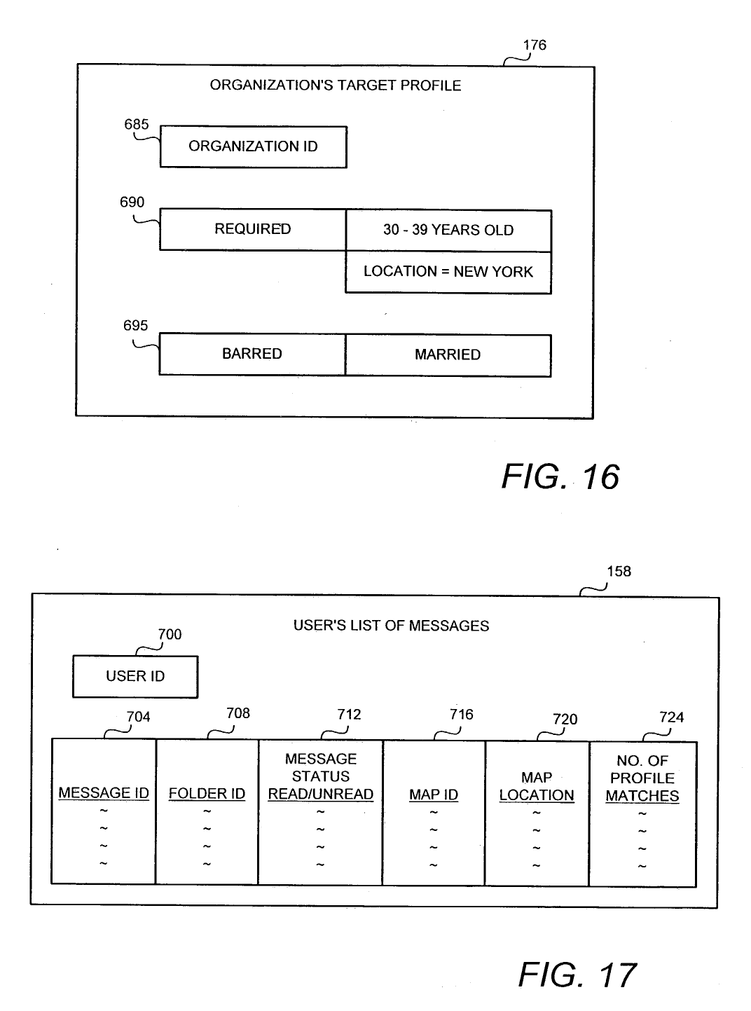

Folder allocation rules 174 are held in folders data section 46. In the present embodiment, folder allocation rules based on the identity of a message sender (if known), or keywords included in either the message content or the message header, are included in the folder allocation rules. Additionally, in the present embodiment, folder allocation rules can include criteria based on the user profile of the sender of the message and/or the target profile that was specified for the message by the sender of the message. An example of a folder allocation rule 174 containing the latter examples is represented schematically in FIG. 15. A first part 650 of the rule is an example in which if three properties are all found in the user profile of the message sender then the message should be allocated to a given folder ID. A second part 655 of the folder allocation rule 174 specifies that if a given single property is met then the message should be forwarded to a given folder ID. A third part 660 specifies that if the target profile of the sender includes the property shown then the message should be allocated to a given folder ID. Two parts 665 and 670 of the rule specify conflict resolution criteria for when more than one folder ID has been specified. In this case, part 665 specifies that if there are two folder IDs specified then respective copies of the message should be allocated to each folder ID that has been specified. Part 670 specifies that if more than two folder IDs have been specified, then the message should only be allocated to a single folder ID according to a priority list of the possible folder IDs which is included in part 670.

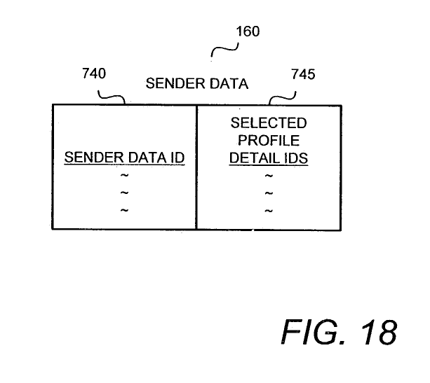

The contents of organizations data 154, namely organizations target profiles 176 and users' lists of organizations 178, will now be described. An example of an organization's target profile 176 is shown in FIG. 16. The organizations' target profiles of the present embodiment contain the same options as for the message specific target profiles described earlier. However, in contrast to the earlier described target profiles, the organizations' target profiles functionally belong in the reference section 142 of data storage 126. This is because it is independent of individual messages, and is instead used when new users are entered into the system, or when existing users wish to re-define which organizations they are to be associated with. In the example shown, for a given organization ID 685 the target profile has a required section 690, and a barred section 695. This example represents an organization's target profile for a social club for 30-39 year olds in New York wishing to meet prospective marriage partners. Married users are excluded, however single, divorced or widowed users are not. In the present embodiment, the different target profiles of different organizations are compared with users' profile data to provide for each user a shortlist of organizations that an individual user may wish to be associated with. Thereafter each individual user makes a selection of some or all of the organizations within his shortlist, to effectively register with those organizations, although those organizations never learn the identity of the individual users without their permission. For each user, a users list of organizations 178 is stored as part of organization data 154.

The format of processed messages 156 was described earlier above with reference to FIG. 5b. The other contents of the data 144 prepared for recipients, namely users' lists of messages 158 and sender data 160, will now be described.

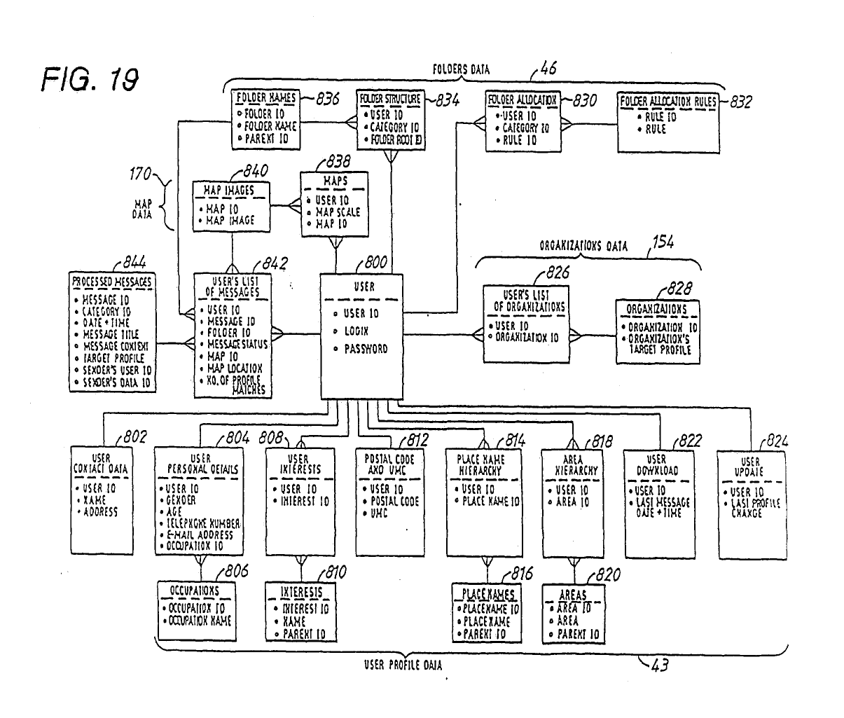

When server 2 has compared a target profile of a message with user profiles to determine those users to which the message should be allocated, then the message ID of that message is added to users' list of messages. An example of a user's list of messages 158 is shown in FIG. 17. In the present embodiment, a specified user ID 700 is linked to each of the following six items. The message ID 704 is the unique identification of the message which has been allocated to the user. The folder ID 708 indicates which of the user's folders the message is to be transferred to when delivered to or retrieved by the user. Message status (read/unread) 712 indicates whether the message has been downloaded or read by a recipient user. Map ID 716 indicates the particular map which needs to be transferred to or indicated to the user for displaying the relative location of the sender and receiving user. Map location 720 is data indicating where on the indicated map 716 an indication should be given of the location of the sender of the message. This data is given in UMC coordinates in the present embodiment such that it corresponds to the UMC calibration of the given map. Finally, data 724 indicating the number of profile matches that have been achieved for this message is included in the present example. This can be used by a recipient user to assist him in deciding whether to accept or open the message.

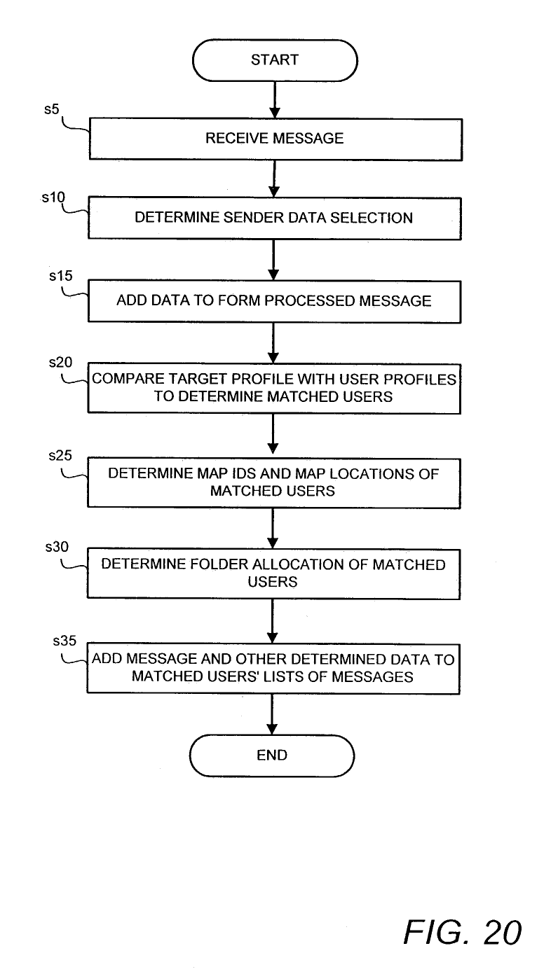

In the present embodiment sender data 160 (represented schematically in FIG. 18) serves the function of a look-up table by which a list 740 of the sender data IDs 196 included in processed messages 190 are cross-referenced to a list 745 of profile detail IDs that have been selected, which themselves relate to given fields in the user profile data structure. This enables the relevant properties to be indicated to a recipient of the message.

Considering now all the data of data storage 126, this is stored in data storage 126 by any appropriate data handling means, for example, a conventional database operated by computer software. A preferred choice is a commercially available database, e.g. Oracle (TM).

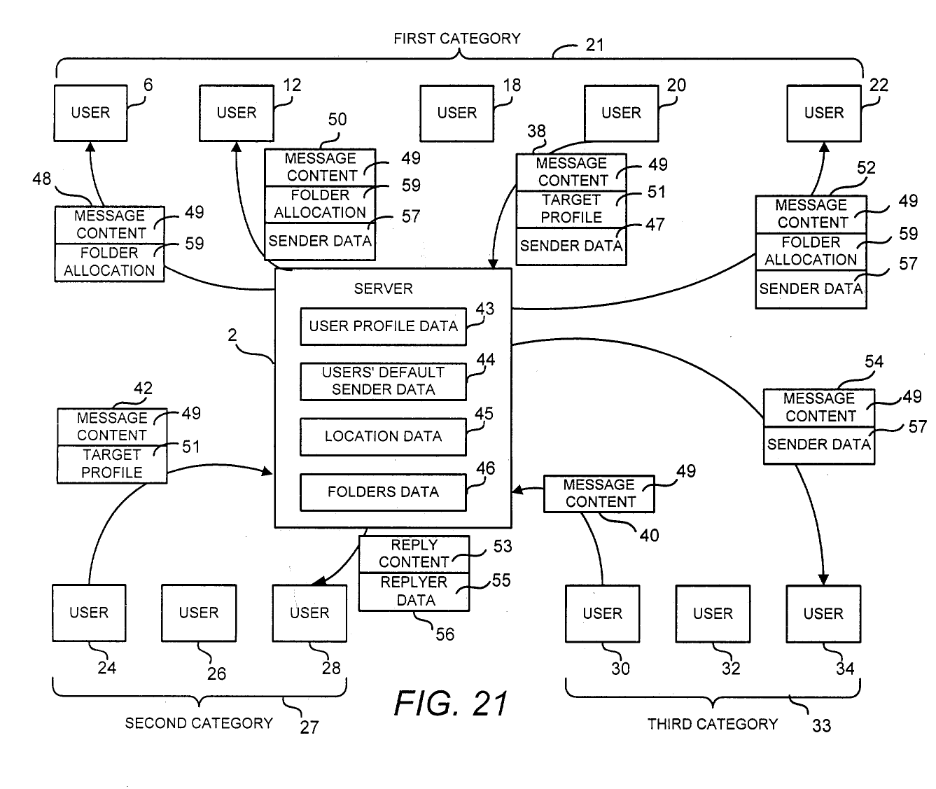

A preferred version of a database structure by which the present embodiment is implemented will now be described with respect to some of the data. Data storage 126 is implemented as a relational database in which the data is stored as entities 800 to 844 schematically represented in FIG. 19 as tables. The entities are linked within the database in conventional manner, the links being schematically represented in FIG. 19 by the lines between the entities. As is conventional, some links are one-to-one, some links one-to-many, and some links many-to-many. A “one” connection is shown by a single line joining the entity, a “many” connection is shown by three lines joining an entity.

For each user there is a user table 800 containing a unique user ID allocated to the user by control 124, a unique log in name for the user and a conventional password. User table 800 is accessed by control 124 whenever a user logs in to server 2.

User table 800 is linked to user contact data table 802 containing user ID, name and address. User table 800 is also linked to a number of tables constituting user profile data 43, as follows. User personal details 804 contains user ID, gender, age, telephone number, e-mail address and occupation ID, and is itself linked to occupations table 806, containing occupation ID and occupation name, in order to relate to the occupation ID entry in user personal detail table 804. User interest table 808 contains user ID and interest ID. This table is itself linked to interest table 810, which contains interest ID, name (of the interest) and parent ID. Parent ID identifies a higher order interest ID from which a lower order interest is derived in the tree structure hierarchy described earlier with reference to FIG. 8.

Postal code and UMC table 812 is a further table connected to user table 800. Place name hierarchy table 814 contains user ID and place name ID, and is consequentially itself linked to place names table 816 which contains place name ID, place name and parent ID, defining a further tree structure. Area hierarchy table 818 contains user ID and area ID, and is linked to areas tables 820 containing area ID, area and parent ID. User download table 822 contains user ID and a specification of the data and time of the last message downloaded by the particular user. User update table 824 contains user ID and the date and time of when the user last changed his profile.

Also linked to user table 800 are tables constituting organizations data 154, which are as follows. User's list of organizations table 826 contains user ID and organization ID, and this is linked to organizations table 828 which contains organization ID and organizations target profile.

Also linked to user table 800 are various tables implementing folders data 46, which are as follows. Folder allocation table 830 contains user ID, category ID and rule ID, and is itself linked to folder allocation rules tables 832 containing rule ID and rule. Folder structure table 834 contains user ID, category ID and folder rule ID, and is itself linked to folder names table 836 containing folder ID, folder name and parent ID.

User table 800 is also connected to data implementing map data 170, as follows. Maps tables 838 contain user ID, maps scale and map ID, and are themselves linked to map images table 840 which contains map ID and map image. User table 800 is also linked to users list of messages table 842, which implements the users list of messages 158 as described earlier above. Users list of messages table 842 contains user ID, message ID, folder ID, message status, map ID, map location and number of profile matches. Users list of messages table 842 is therefore also linked to folder names table 836 and map images table 840. Users list of messages table 842 is also linked to processed messages table 844, which implements the process messages 156 as described earlier above. Process messages table 844 contains message ID, category ID, date and time, message title, message content, target profile, the message senders users ID and the message senders data ID.

The remaining data described earlier above as contained in data storage 126 is implemented in similar fashion.

An advantage of this particular arrangement is that the searching and matching procedures to be carried out, when for example, a target profile is to be compared with users profile data, can be carried out efficiently and quickly because the user profile data is split into discrete items contained in separate tables. A further major advantage is that with this format of database, any piece of information that can be shared between different users need only be stored once, as opposed to being duplicated for each user. For example, the specification of a name of a particular interest need only be made once in the interest table 810 which is shared between all users, and is linked to multiple user interest tables 808. This applies also to the storage of the message content itself in process messages table 844, which is a further example of a single table that is shared by many users via reference to each user's list of messages table 842. This represents a major saving in storage for a single message that is to be distributed or made available to a plurality of recipient users, and is thus advantageous compared to conventional e-mail.

A preferred method of processing a message using the above described data structures will now be described with reference to FIG. 20. In overview, after receipt of the message, server 2 determines which sender data should be made available with the message. Server 2 then adds indication of the determined sender data, and certain other data, to the message to form a processed message. Server 2 compares the message's target profile with the user profile data it holds and determines which users the message should be allocated to. Server 2 then determines various additional forms of information that are to be made available to recipients of the message, as follows. On the basis of the relative location of the sender of the message and each user allocated to receive the message, server 2 determines for each user which map should be indicated to the user and which location on the map specifies the position of the message sender. Server 2 also determines which folder of each recipient user the message should be directed to. Finally, server 2 adds the message, plus the additionally determined data, to the user's list of messages of each user who has been allocated to receive the message.

The procedure will now be described in more detail with reference to FIG. 20. At step S5 a message, containing the elements shown in FIG. 5a, is received at server 2.

At step S10, control 124 determines which sender data related to the sender of the message, as described earlier above, needs to be selected and made available to recipients of the message. As described earlier, where no specific sender data selection is specified by the message sender, then the default sender data for that user is selected by control 124.

At step S15, control 124 determines and adds the data already described with reference to FIG. 5b to the received message to form a processed version of the message which is then stored.

At step S20, control 124 analyses the database contents to determine those users which have user profile data that complies with the target profile attached to the message. Determination of which user profiles match the target profile is implemented by a conventional database querying procedure employing Structural Query Language (SQL), since all the criteria described above can be determined on a yes/no basis. Even in the case of location, the above described form of the place name hierarchy enables verification of matching when place names are included in the target profile. A further possibility is for the target profile to specify that recipients of the message should be located within a given distance from the location of the message sender, or even from a particular other place. In this situation, in order for the standard database query procedure to be implemented, the following procedure is first carried out by control 124. Control 124 determines the square distance of each user from the message sender by analysing the UMC data held for each user. Preferably however, the number of users this needs to be performed with is significantly reduced by identifying the particular area within the area hierarchy structure 168 that is the smallest area in which the distance criteria can be met. The square distance calculation need then only be performed for those users who contain that area within their user profile. Another possibility when target profile contains a maximum distance is to treat this as only being so specific as to allow server 2 to define all users within whichever is the smallest hierarchical level of the area hierarchy structure which allows all distances under the distance criteria to be included, even if some in fact would be found to be beyond it with an individual calculation of the square distance. Whether the location details should be matched before other details, or indeed the choice of which order any of the other profile details should be compared in is determined according to the requirements of the particular system under consideration.

At step S25, control 124 determines, for each user ID that has been found to be a match, the appropriate map scale and hence the map identity for inclusion with the message. Control 124 also determines the location on the map where an icon representing the location of the message sender rule is to be placed on display of the map on the eventual recipient user's communications apparatus. Optionally, the UMC values defining the position of the message sender can be made available to the allocated recipients, so that their computer or other apparatus can use this information to derive such things as route maps.

At step S30, control 124 compares details of the processed message with the earlier described folder allocation rules, for each recipient user, to determine which folder or folders the message is to be directed to.

At step S35, control 124 adds the processed message and the additional data determined in steps S25 and S30 to a list held for each user consisting of all messages which have been made available for that user i.e. the user's list of messages as described earlier.

It is noted that steps S25 and S30 can be performed in either order. Additionally, the basic processed message can be added to a user's list of messages prior to one or both of steps S25 and S30 being performed, and in this case the information determined in those steps is added to the list later. The basic method of allocating the messages and making them available to the recipient users is thus completed. Thereafter the messages are transmitted to the recipient users or retrieved by them in any number of ways. One option is for server 2 to send all new messages to a user whenever that user next logs on to the system. Alternatively, this can be performed only in response to specific requests for transmission by a recipient user. Furthermore, in either case, the selected sender data can either be always sent with a message or only sent when specifically requested by the recipient user.

In the above described method, the target profile was of the form schematically represented in FIG. 13a. The target profile can instead be in the form schematically represented in FIG. 13b, i.e. including a specified number of recipients, and including profile characteristics in an order of priority. For this type of target profile, at step S15 in the above method the highest priority profile characteristic is compared with users' profiles to determine the number of matched users. If this is greater than the specified number of receivers, then the procedure is repeated for the next characteristic in the priority order until the number of matches becomes equal to or less than the specified number of recipients. Alternatively, other algorithms can be employed as described earlier with reference to FIG. 15b.

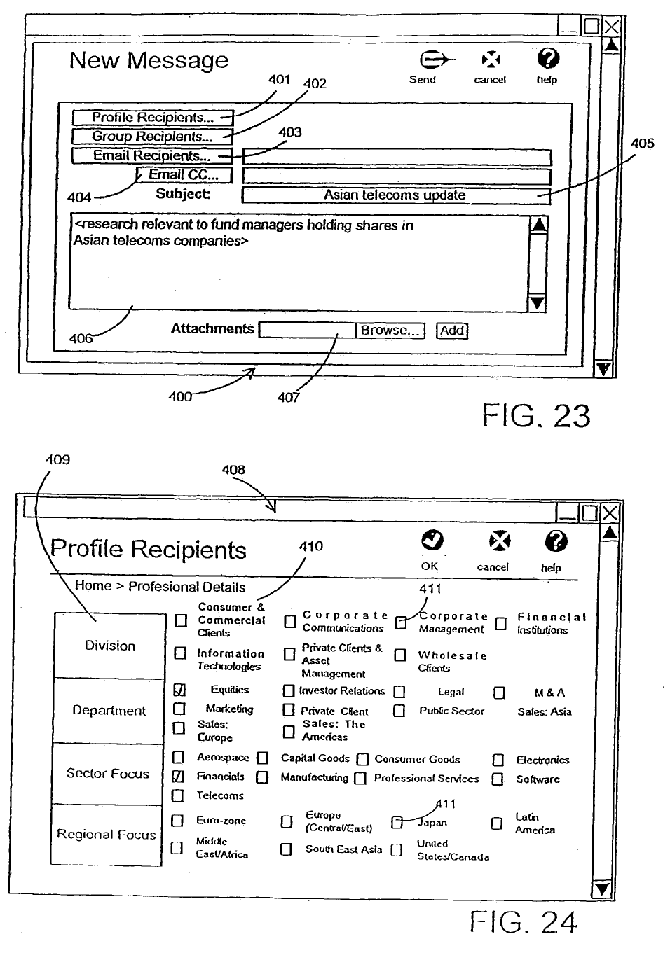

The method described above with reference to FIG. 20 described the process steps carried out by server 2 in one embodiment. The corresponding operation of a communications system as a whole will now be described with reference to FIGS. 21 and 22.

FIG. 21 shows a communications system having eleven users. The users are divided into different categories, in the present embodiment three categories. In the present example the first category 21 is private users, the second category 27 is commercial companies and the third category 33 is non-profit organizations. Users 6, 10, 18, 20 and 22 are in the first category, users 24, 26 and 28 are in the second category and users 30, 32 and 34 are in the third category.

Server 2 receives messages from different users. Server 2 is shown receiving a message 38 from user 20, a message 42 from user 24 and a message 40 from user 30. Each such message includes a basic message content portion 49. The message content 49 can include any appropriate information content including inter alia, either individually or in any combination, text, HTLM, graphics, speech, other audio content, video and any other multi-media content. Messages 38 and 42 additionally include respective target profiles 51. The target profiles 51 have been specified by the respective users 20 and 24 to define characteristics of potential recipient users that should be met in order for such users to be allocated to receive the message.

Server 2 contains user profile data 43. This contains data specifying, for each user, characteristics which the user has chosen to include in his own user profile. Server 2 compares the received target profile with the user profile data 43 to determine which users have profiles which match. These users are duly allocated to receive the corresponding message. In the present embodiment, users of the third category (organizations) do not include target profiles with messages they send, hence message 40 is shown without any target profile attached. Instead, in the present embodiment, users optionally select to be associated with one or more specific organizations, and messages from such an associated organization are automatically allocated to the corresponding user. The organizations do, however, specify a form of target profile, which server 2 matches with individual users profiles in order to provide a shortlist of organizations for individual users, who can then use the shortlist to assist their selection of which organizations they wish to be associated with.

Following allocation of messages to appropriate recipient users, the messages are transmitted from server 2 to respective users, either actively by server 2 or retrieved on demand by the users. FIG. 21 shows, by way of example, a message 48 being sent to user 6, a message 50 being sent to user 12, and a message 52 being sent to user 22, all in the first category. It is noted that these messages may have originated from other users within the first category or users within the second and third categories. It is also noted that a private user is able to send a message to a user in a category that does not have a user profile held at server 2. In the present embodiment organizations (the third category) do not have user profiles. However, when a user in the first category is associated with a user in the third category (i.e. an organization) he is able to send messages to that organization, receipt of such a message by a user in the third category being illustrated in FIG. 21 by receipt by user 34 of message 54. Users are also able to reply to messages, for example a reply 56, comprising reply content 53 and reply data 55, is shown being received by the user 28.

Selected items of data from a user's profile are attached to messages by server 2 when sent to recipient users. This data is shown as sender data 57 in messages 50, 52 and 54 in FIG. 21. The selection of which data from the senders users' profile is to be sent can be specified by the user when forming the message that he sends to server 2. Such a selection is represented by the sender data 57 shown in message 38, which has been specified by user 20. Alternatively, when the message sender does not specify a specific selection, as in the case of messages 40 and 42 sent by users 24 and 30 respectively, the sender data that is sent to recipient users is determined according to a specification default sender data specification, which is previously stored for each individual user as users' default sender data 44 in server 2. A users' default sender data can define simply that no sender data should be sent along with the message, as is the case with message 48 shown being received by user 6 in FIG. 21.

One particular form of user profile data that can be included in the sender data is data relating to the location of the sender of a message. In the present embodiment, one specific aspect derived from the location data is always included with messages when sent to recipient users, and this will be described in more detail later below with respect to FIG. 22.

Server 2 also holds folders data 46 which contains details, for each user, of a folder structure that the user has specified for messages to be allocated to automatically according to specified criteria or allocation rules. Hence, in the case of messages allocated to users who have indeed specified such a folder structure, such messages also include details 59 of the determined folder allocation, as shown in the case of messages 48, 50 and 52. Users are able to specify folder allocation rules that relate to other characteristics of the sender of the message which are known to the server 2, including details from the user profile of the sender of the message and/or details from the target profile included in the message as sent by the message sender.

FIG. 22 schematically illustrates further optional functions performed by server 2 and user apparatus 10,16. Server 2, user 6, user 12 and user 18 are shown positioned at specific locations in the USA 61. It is noted that the relative spacing between the users has not been shown to scale, and users 6 and 12 are in fact located in the same city. Server 2 also holds location data 45. The location data 45 is used by server 2 to determine the location of the sender of a message relative to the location of each user allocated to receive the message. This information is sent from server 2 to the recipient users as part of the overall message. In the example shown in FIG. 22, user 6 has sent a message to the server that has been allocated to user 12 and user 18. The communications apparatus 10 of user 12 includes a display 60 which, on receipt of the message, displays sender data 64, a message content 62, and furthermore, a map 66. The map 66 has been specified by server 2 as being of an appropriate scale to show the relative location 69 of the sender of the message to the location 68 of user 12, which is placed at the centre of the map. Because user 6 and user 12 are in the same city, the map is relatively detailed. The communications apparatus 16 of the other recipient of the message, user 18, includes a display 70, which on receipt of the message displays sender data 74, the message content 72, and a map 76. This map shows the location 78 of the recipient user 18 and the location 79 of the sender of the message. In the present embodiment the maps specified by server 2 are arranged to always show the recipient user at the centre of the map, unless the relative positions of the sender and user lead to a scale of map that shows an entire country, in this case the USA, in the map, in which case the map is arranged to locate the outline of the country centrally, as is the case with map 76.

Details of different possible arrangements of sender and recipient users' apparatus and procedures they can perform will now be described. User communications apparatus 4, 10, 16, implemented in the form of suitably configured computer apparatus 121, operates in one embodiment fundamentally as a conventional web browser used to control access to server 2 over the Internet. However, in other embodiments, the apparatus contains dedicated functionality for sending messages to server 2 and accessing messages at server 2 that are intended for the user and downloading these messages. This functionality can be embodied as hardware or software, the software being configured by computer program instructions and possibly also data. These may be supplied by any one or a combination of the following: as a signal via communications interface 122, on a removable medium (RM) 133, for example a CD ROM placed in removable storage medium receiver 132, and input via the user interface 128. Further details of possible functions thereby implementable are as follows.

Titles of messages allocated to a user are displayed on display 130. The messages may be displayed according to the category ID of the messages, i.e. corresponding to which category of user sent the message. Furthermore, the message titles can be arranged such that only messages from a given category, as selected by the user, are presented at any one time. In embodiments where messages are downloaded to the computer apparatus, they are stored in data storage 126, and accessed by the user in the conventional manner as employed in the case of e-mail for example. However, one difference to conventional e-mail is that rather than an identity of the sender or the message being indicated, instead some other appropriate information is indicated, such as the target profile, or the number of matches to the target profile.

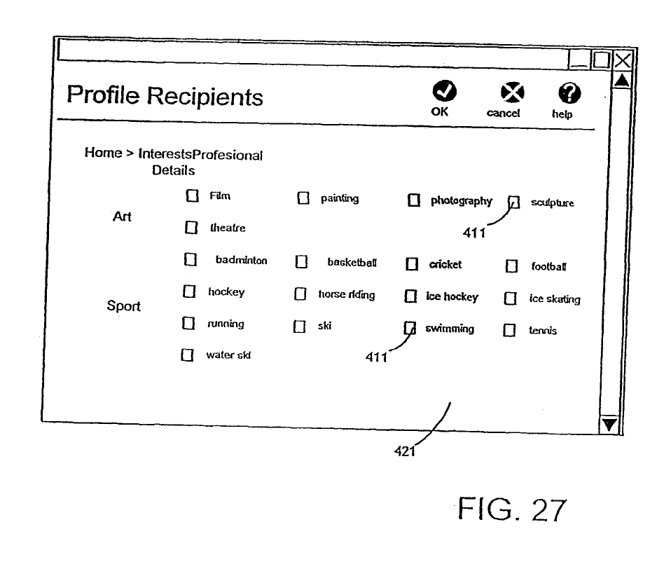

FIGS. 23 to 27 show screens that may be displayed to a user wishing to send a message.

FIG. 23 shows a screen 400 that may be displayed when a user selects to send a new message. This screen has buttons 401 to 404 labelled profile recipients, group recipients, email recipients and email CC. Button 403 enables the sender to select an addressee in conventional manner by inputting or selecting an email address from an address book stored at the sender's computer or communication apparatus while button 404 enables the sender to select people to whom the message is to be copied in conventional manner and button 402 enables the sender to select to send the message to a predefined group of addressees. A message entry window 405 is provided for the sender to input their message using, for example, the keyboard of their computer or communication apparatus. A subject window 406 is provided for enabling the sender to enter a message subject and an attachments window 407 is provided for enabling the sender to attach files in known manner.

The profile recipients button 401 enables the sender to elect to send the message to recipients identified not by their name, email or network address but by a target profile. When the sender clicks on button 401, a target profile defining screen is displayed to the sender on the display 130 that displays to the sender different target profile elements that the sender can select. The actual target profile elements that can be selected will depend upon the particular environment of the user. Thus, for example, if the sender is in a work environment then the database of available target profile elements may be specifically tailored to that work environment while if the sender is sending messages in a personal capacity in his or her leisure time then the available profile elements may be specifically tailored to leisure activities. This enables the sender to design a target profile specifically for a particular message.

FIG. 24 shows an example of a target profile defining screen 408 showing the target elements available for personnel working in the commercial sector. As shown the screen 408 shows target profile elements 410 divided into four groups (division, department and sector and regional focus) 409. As shown each target profile element is associated with a check box 411 and clicking in the check box causes that particular target profile element to be added to the target profile that the sender is designing for this particular message. Thus, for example, clicking in the check box associated with the “Corporate management” adds that target profile element to the target profile. As mentioned above, the target profile elements or categories may have a hierarchical or tree structure so that a target profile element may be a parent target profile element of one or more children target profile elements related to specific subject areas within or related to the parent target profile element. For such parent target profile elements clicking on the parent target profile element name rather than in the check box leads to another screen that listing the children target profile elements. There may of course be more levels to the tree structure so that each child target profile element may itself have children target profile element and so on.

The screen 408 shown in FIG. 24 enables a sender to select combinations of target profile elements so that when the sender clicks on the OK button 412 shown in FIG. 24 the target profile consists of a logical AND combination of target profile elements. However, a more advanced option may be provided so that when the sender clicks on the OK button 412 a further screen is displayed that allows the sender to edit the target profile and to modify the manner of combination of the target profile elements. FIG. 25 shows such a screen 413. This screen includes description windows 414 each showing a description of a selected target profile and each associated with an edit button 415 (that returns the sender to the screen shown in FIG. 24) and a delete button 416 that enables deletion of the associated target profile element. At least some of the description windows are associated with an “Add AND” 417 button that returns the sender to the screen shown in FIG. 24 and enables the sender to add in a logical AND combination a further target profile element selected from the screen shown in FIG. 24. An “Add OR” 418 button is also provided that returns the sender to the screen shown in FIG. 24 and enables the sender to add in a logical OR combination a further target profile element selected from the screen shown in FIG. 24. A “Swap AND with OR” button 419 is also provided that swops all existing AND buttons for OR buttons enabling the sender to easily modify the selected logical combination. FIG. 26 shows a screen 420 similar to screen 413 shown in FIG. 25 (different target profile elements are shown selected) after the sender has clicked on the “Swap AND with OR” button 419 so that this is now a “Swap AND with OR” button 419′ and the Add OR and Add AND buttons 418 and 417 are now Add AND and Add OR buttons 418′ and 417′. These features enable the sender to select many different logical combinations of target profile elements.

FIG. 27 shows an example of a target profile defining screen 420 that may be displayed when the available target profile elements (at least some of them) are related to art and sports. Again clicking in the check box 411 causes that particular target profile to be added to the target profile that the sender is designing for this particular message. Thus, for example, clicking in the check box associated with the sporting target profile element basketball adds a requirement to the target profile that the message recipient be interested in basketball. As mentioned above, each of the target profile elements (in the example shown interests) listed may itself have child target profile elements so that clicking on the target profile element listed rather than in the check box leads to another screen that defines children target profile elements, for example, in the case of the sporting interest basketball, whether the requirement is interest as a spectator or as a player and, if so, the skills level. Again, the advanced option described above with reference to FIGS. 25 and 26 shows such a screen 413.

The sender can select any logical AND combination of the available target profile elements and children target profile elements enabling a target profile to be designed by the sender for that specific message that is as detailed or general as the sender requires. If the advanced option described with reference to FIG. 25 is provided the sender can also select many different combinations of logical AND and OR operations for the selected target profile elements.

The actual nature of the target profile elements will depend upon the particular application for the system. Examples of types of target profile elements are any one or more of: personal interests, professional interests, office identification, location, current location, department, project membership, group membership, professional qualifications, skills, job function, job title/position, age, gender, years service. The target profiles need not necessarily be keywords as shown but could be strings or ranges so that a user profile element that contains the string or falls within the range defined by a target profile element will be considered a match for a target profile element.

As an example the sender may define a target profile specifying as recipients only those users of the system that, on the basis of their user profile, are in a certain age range, live in a certain location and have an interest in playing basketball.

As another example, where the system is used in a working environment, for example on an Intranet within a company, the sender may define a target profile that specifies as recipients only those users whose user profiles indicate, for example, that they are in a particular department, that they are in a particular building, that they have a certain job level, that are involved in a particular project, that they have a particular skill or any combination of these and so on enabling, in a work environment, messages to be targeted to specific members of staff, for example only those above a certain grade, only those involved in a particular project or only those having certain skills. This enables the sender to target messages to the correct employees or members of staff without having to know their names or network or email addresses, for example. Also it facilitates targeting of messages to the correct people without the sender having to try to identify, for example, the names of people having an interest or expertise in a particular subject or to identify all the members of a department. This facilitating or correct targeting of messages should also increase efficiency by reducing unwanted and unnecessary email correspondence. A system embodying the invention is for similar reasons useful for inter company cooperation, for example where different companies are involved in the same project and should also be useful in the research and academic fields enabling researchers to receive information about the topics in which they are interested without the sender having to know that they are interested in that particular topic.

It will of course be appreciated that the screens shown in FIGS. 23 to 27 illustrate only one way of defining a target profile and that other ways may be used, for example a sender may select keywords from a list or the system may extract from text typed in by the sender any words that match target profile elements. Also, speech input may be used to select target profile elements.

The sender can repeat the above process each time he wishes to send a message so that each message can have a completely different profile designed by the sender at the time of preparing to send the message and thus specifically tailored to the message. A facility may also be provided to save, under file names chosen by the sender, previously used target profiles for use in subsequent messages having the same or a similar topic, for example the sender may save a basketball target profile for use when sending messages relating to basketball.

Where the system is used within a working environment, then the user profiles may be maintained and updated centrally, for example by a manager, a systems administrator or the personnel department, or by the individual users. As another possibility the user profiles may have a main section that is maintained and updated centrally and a separate personal section that can be updated by the individual member of staff or employee.

Each time the server 2 or intermediate communication apparatus receives a message with its accompanying target profile specific to that message, the server 2 accesses the user profiles for each user of the communications service provided by the server and compares, for each target profile element in the target profile accompanying the received message, the data in the target profile element with data in a corresponding user profile element in each of the accessed user profiles to determine whether any user profile contains user profile data that matches the target profile data accompanying the message. The available user profile elements will of course depend upon the particular application of the system and will correspond as discussed above to the target profile elements of the system with the exception that where the target profile elements can specify a numerical range (for example an age range) the corresponding user profile element may only enable a number (an actual age for example) to be specified. The server 2 then identifies as recipients for the received message any user having a user profile which includes, for all of the target profile elements in the target profile, data matching that in the target profile accompanying the received message where in the case of a string target profile element a match will be considered to have been found if the user profile element contains that string so allowing for wild cards and in the case of a numeric range target profile element a match will be considered to have been found if the user profile element contains a number in the range.

The apparatus is configured so that replies can be sent to the message. Furthermore, the apparatus is configured so that the map specified with a message, and the relative locations thereon are displayed on display 130. Suitable icons can be selected to indicate the location of the message sender and the location of the recipient user on each map. Typically a figure of a house would be used for these locations, however other icons can be allocated according to functions such as the sender data attached with the message or some aspect of the target profile. For example, if the target profile specifies primarily that message recipients be interested in tennis, then the icon may be in the form of a tennis racquet, and so on.

The computer apparatus can be configured to operate along the lines of a conventional desktop application. In this case certain parts of the data described earlier are included in the data storage of the user's own computer apparatus. This can include a list of the user's messages, folders data, specification of the last time the user downloaded information, specification of the last time the user changed his user profile, the map data allocated to that user, and so on. When the map data is stored at the user's own apparatus, this reduces significantly the amount of data that has to be sent from server 2 along with each message in order to show the relative locations in map form. Even when a user has such a desktop application, it can be possible for him to access messages allocated to him at server 2 by means of other computer apparatus and so on. In this respect, and in other respects of the desktop application, details such as synchronisation are performed in analogous fashion to how they are performed in conventional e-mail arrangements. The user's communications apparatus is also configured to prepare message's target profiles, sender detail selection, and so on, and to transmit them to server 2.

The user's computer apparatus 121 can be a personal computer (PC), laptop computer, or other communications device with suitable computing capability, including inter alia an electronic organizer, or an appropriate processing means coupled to or forming part of a mobile telephone.

In the above embodiments users can reply to messages in a manner similar to conventional e-mail. However, because the identity of the message sender is not known to the message recipient, when a reply is sent to server 2, control 124 identifies the message ID of the message that is being replied to and then uses that to identify the sender ID of the original sender of the message. Control 124 then allocates the reply to the list of messages of the user who sent the original message.

Further details will now be given with respect to the fact that users can be allocated into different categories 21, 27, 33, as represented schematically in FIG. 21. In the embodiments above, the first category 21 is private users, the second category 27 is commercial companies, and the third category 33 is non-profit organizations. Messages sent from users of either the first or both the first category and second category have target profiles attached, whereas messages sent from the organizations of the third category do not contain target profiles. Instead target profiles raised by organizations are used in the process of users selecting which organizations to be associated with, as described earlier with reference to FIG. 16. Once users are associated with a particular organization, then in the above embodiment they receive all messages sent by that organization. However, in other embodiments, particular users can be associated with a given organization, or other type of user, but nevertheless messages do also include individual target profiles which further narrow the list of users who will receive the messages. Furthermore, when a user is associated with one or more organizations, then procedures applicable to the different messages coming from different categories, such as being listable on a user's equipment by category, can also be applied to the particular organization selected by them being classified as categories also. Furthermore, any number of categories can be included in arrangements according to other embodiments. For example in certain other embodiments there is in fact only one category, consisting of private users only. Also, any of the attributes or procedures applicable to any of the given categories can be applied to more than one category. In other words although in the main embodiment above each of the three categories has different rules, they can alternatively be arranged such that two of the categories have the same rules as each other. Referring explicitly to the main embodiment above, individual users could instead be associated with specific commercial companies as well as with specific organizations.

In other embodiments, a user can specify different user profiles to be applied to target profiles from different categories of message sender.

In other embodiments access to discussion forums is provided. When a user is associated with, for example, a specific organization, so that the organization appears on that user's list of organizations, then in addition to one-off messages, messages relating to one or more selected discussion forums are distributed to the user.

Further forms of category may also be defined. Such further forms of category can include users from any of the basic types of category described earlier with reference to FIG. 21. For example, a category may consist of all private users associated with a specific organization (or company) and also the organization (or company) itself, or even all users associated with some sub-set of a specific organization (or company), such as a specific discussion forum or bulletin board of the specific organization (or company). In this case a message can be sent from a user in a given further form of category to be allocated or distributed to other users in the same further form of category. Server 2 adds the appropriate category ID 189 when forming processed message 190 for this further form of category in the same way as was described earlier with reference to the basic types of category.

Furthermore, for either the basic forms of category or the further forms of category, lists of messages and titles of messages etc. to a user can be arranged graphically on display 130 according to category. Furthermore, a graphical user interface for the display can be arranged such that when a user initiates sending of a message whilst displaying or selecting such a category, i.e. from ‘within’ the category, this informs server 2 that the category ID for the message being sent by the user is the category displayed or selected.

Referring again to FIG. 21, one such further form of category can 30 comprise those private users, say users 6, 12 and 18, from the first basic category 21 who are associated with user 30 which is a non-profit organisation of the third basic category 33. In this case, user 6 is able to send a message to server 2 for allocation to all other users in the same further form of category, i.e. users 12 and 18. Optionally, user 2 can further include a target profile, and then the message is only allocated to those other users in the same further form of category who also have user profiles which match the target profile.

The folder structure shown in FIG. 14 can be arranged in terms of categories, whether the above described basic forms of category or the above described further forms of category.

Referring now to the earlier described folders allocation rules 174, it is noted that another outcome of the rules that can be defined by a user is that messages meeting certain criteria should be “deleted”. This would be implemented by the messages so allocated being removed from that user's list of messages.

Referring again to the method described with reference to FIG. 20, according to one implementation, after step s15 the current number of profile matches is communicated to the sender of the message. He is thus able to review whether his target profile has been matched with an appropriate number of recipients. If he is not satisfied he can then amend his target profile. This new target profile is then matched with user's profiles and the process repeated until the user is satisfied, thereafter the remainder of the procedure shown in FIG. 20 is carried out.

In each of the above embodiments, attachments can be included as part of an overall message. One way to implement this is to provide a separate section in data storage 126 for storage of attachments. When implemented in the database structure of FIG. 19, a message-attachments table containing message ID and attachment ID is linked to user table 800, and the message-attachments table is itself linked to a further table containing attachment IDs and attachments.

In other embodiments of the present invention, one or more particular aspects can be omitted, thus providing a simpler system which nevertheless exhibits the advantages due to the aspects remaining. The aspects that can be omitted in this fashion, in any combination, include the following. Method step s20 can be omitted, in which case the relative locations of the message sender and a message receiver are not indicated in the fashion described above. In such situations, other location data may or may not be used as part of the profile matching procedure. When step s20 is not included, then it is possible to omit or reduce data in user profiles and target profiles that refers to location, and also it is possible to omit all or some of the location data 150.

Similarly it is possible to omit the direction of files into specific different folders. In this case step s25 need not be carried out in the method shown in FIG. 20, and any or all of folders data 46 need not be included in the data arrangement.

It is also possible to omit the capability to attach sender data with messages. In this case step s30 of the method shown in FIG. 20 is omitted, and correspondingly sender data 160 and user's default sender data 44 is omitted from the data that is stored.

Also, if none of the categories described earlier above require specific target profiles or user's lists, then data related to this need not be included, i.e. referring to the above explicit embodiment, organization's data 154 need not be included.

It is further noted that the procedure encompassed by step s20, i.e. the above described procedure relating to defining relative locations of a message sender and a receiver of a message and using that information to make available and/or display such information in the form of maps, including all the details described earlier above in that respect, can be implemented in any type of messaging system, even those not employing user profiles, target profiles or other aspects of the embodiments described above. As such any type of allocation specification can be considered including simple identification of a user name or address or other identity.

Similarly, the above described procedure for adapting location data to a form in which a distance criteria query can be answered by the database can be advantageously applied in any database querying procedure for a database which would otherwise not be able to answer such a query (i.e. a query specifying whether a user of an arrangement whose details were held on the database had a location within a given distance from a given other location).

It is further noted that the above described aspect, wherein the messages are held at server 2 in a database arrangement such that only one copy of the message is required to be stored whilst other separate data indicating a plurality of users for which that message is allocated, can be applied to any electronic message handling service, even if the other details of the above embodiments are not included. Similarly, the remaining details of the above embodiments can still be employed to advantage even in an alternative server arrangement in which duplicate copies of the message are in fact stored.

It is further noted that the procedure and/or data structure arrangement by which users can specify different types of data to be included as sender data attached to the messages could be applied to other message handling systems other than those described in the above embodiments, including other arrangements which do not employ target profiles or location details.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

We claim:

1. A method of enabling communication of messages from a sender communication apparatus to one or more recipient communication apparatus via a communication service provided by an intermediate communication apparatus, which method comprises:
at the sender communication apparatus, for each message that a sender wishes to send, the steps of:
enabling the sender to select any combination of a plurality of different target profile elements to enable the sender to define, at the time of sending a message, a recipient target profile consisting of a combination of different target profile elements selected by the sender, so allowing the sender to define different target profiles for different messages to enable the sender to target a specific message to a specific recipient audience desired by the sender;
receiving from the sender data representing a message that the sender wishes to send and data representing the sender's selection of said different target profile elements and their combination for that particular message to define a target profile that is specific to that particular message; and
communicating the message and the target profile specific to that message to the intermediate communication apparatus; and
at the intermediate communication apparatus the steps of receiving messages each with the accompanying target profile specific to that message and, in response to receipt of each message,
accessing a database containing, for each user of the communication service provided by the intermediate communication apparatus, a user profile having a plurality of user profile elements each containing data representing information related to the corresponding user for that user profile element,
comparing the target profile accompanying the received message with each of the accessed user profiles to determine whether any user profile contains a combination of user profile elements that matches the combination of target profile elements in the target profile accompanying the message, and
identifying as a recipient for the received message any user having a user profile which contains a combination of user profile elements that matches the combination of target profile elements in the target profile accompanying the received message.

2. A method according to claim 1, wherein the steps carried out at the intermediate communication apparatus further include sending the message to the communication apparatus of the or each identified user.

3. A method according to claim 1 or 2, wherein in the identifying the step the intermediate communication apparatus identifies recipients solely on the basis of the target profile accompanying the received message.

4. A method according to claim 1, 2 or 3, wherein the step at the sender communication apparatus of enabling a sender to select target profile elements includes the step of displaying to the sender on a display of the sender communication apparatus at least one target profile element input screen.

5. A method according to any one of claims 1 to 3, wherein the step at the sender communication apparatus of enabling a sender to select target profile elements includes displaying to the sender on a display of the sender communication apparatus at least one display screen displaying different target profile elements selectable by the sender.

6. A method according to any one of the preceding claims, wherein the step of enabling a sender to select target profile elements at the sender communication apparatus includes enabling the sender to specify input target profile elements related to at least one of: personal interests, professional interests, location, current location, office, department, project membership, group membership, qualifications, skills, job function, job title/position, gender, age, years service, required of a recipient for the message that the sender wishes to send.

7. A method according to any one of the preceding claims, wherein the enabling step enables the sender to select target profile elements as alternatives as well as in combination.

8. A method according to any one of claims 1 to 6, wherein the enabling step enables the sender to select target profile elements combined by both logical AND and logical OR operations.

9. A method according to any preceding claim, further comprising at the intermediate communication apparatus indicating the number of recipient users to the recipient users.

10. A method according to any preceding claim, wherein after the intermediate communication apparatus performs the comparing step, indicating to the sender communication apparatus the current number of matches between the target profile and the user profiles.

11. A method according to claim 10, wherein after indicating the current number of matches, the sender communication apparatus transmits a revised target profile to the intermediate communication apparatus, and this is repeated until the revised target profile is specified by the user to be a final target profile; and the message is communicated to the intermediate communication apparatus after the revised target profile is specified by the user to be the final target profile.

12. A method according to claim 1, wherein the target profile further specifies a required number of recipients and the one or more target profile elements comprises a plurality of criteria in an order or priority;
the comparing step comprises repeatedly comparing the criteria of the target profile in order of priority of the criteria with the user profiles until the number of user profiles which match the target profile to the extent of the criteria so far compared first falls below, or alternatively lies closest to, the specified required number of recipients; and
the identifying step comprises allocating the message to those users whose user profiles are in the number of user profiles which first falls below or alternatively lies closest to the specified required number of recipients.

13. A method according to any preceding claim, wherein the user profiles comprise location data specifying the location of the users and the target profile includes a location target profile element specifying a location criteria.

14. A method according to claim 13, wherein the location data is in the form of a place name hierarchy and the comparing step comprises comparing the location data in the user profiles with the location data in the target profile at a hierarchical level specified in the target profile.

15. A method according to claim 13, wherein the location criteria specified in the target profile specifies a required maximum distance between candidate recipient users and a specified location, wherein the specified location is for example the location of the sender transmitting the target profile, and the location data is in the form of an area hierarchy which is used either to pre-filter the number of candidate recipient users for whom a more accurate matching procedure is then performed or to provide an approximate matching procedure for the location criteria.

16. A method according to any preceding claim, wherein the users of the communication service are divided into a plurality of categories; users in a first category select one or more users in a second category to be associated with, preferably from a shortlist of users in the second category which is provided by the intermediate communication apparatus by comparing target profiles supplied by the users of the second category with the user profiles; and
the intermediate communication apparatus only compares the target profile transmitted with the message with user profiles of those users who are associated with the user who transmitted the target profile and message.

17. A method according to claim 16, wherein the communication apparatus of a user in a second category transmits a message but no target profile, and the intermediate communication apparatus allocates the message to all those users in the first category who are associated with the user who transmitted the message.

18. A method of enabling communication of messages from a sender communication apparatus to one or more recipient communication apparatus via a communication service provided by an intermediate communication apparatus, which method comprises:
at the intermediate communication apparatus the steps of receiving messages each with an accompanying target profile specific to that message and containing a combination of target profile elements and, in response to receipt of each message,
accessing a database containing, for each user of the communication service provided by the intermediate communication apparatus, a user profile having a plurality of user profile elements each containing data representing information related to the corresponding user for that user profile element,
comparing the target profile accompanying the received message with each of the accessed user profiles to determine whether any user profile contains a combination of user profile elements that matches the combination of target profile elements in the target profile accompanying the message, and
identifying as a recipient for the received message any user having a user profile which contains a combination of user profile elements that matches the combination of target profile elements in the target profile accompanying the received message.

19. A method according to claim 18, further comprising the steps performed by the intermediate communication apparatus in any one of claims 2 to 17.

20. A method performed by a communication apparatus of a user in a communications system, the method comprising the following steps:
providing a user profile to an intermediate communication apparatus, wherein the user profile specifies characteristics related to the corresponding user; and
receiving or retrieving a message allocated to the user by an intermediate communication apparatus of the communications system.

21. A method of enabling communication of messages from a sender communication apparatus to one or more recipient communication apparatus via a communication service provided by an intermediate communication apparatus, which method comprises:
at the sender communication apparatus, for each message that a sender wishes to send, the steps of:
enabling the sender to select any combination of a plurality of different target profile elements to enable the sender to define, at the time of sending a message, a recipient target profile consisting of a combination of different target profile elements selected by the sender, so allowing the sender to define different target profiles for different messages to enable the sender to target a specific message to a specific recipient audience desired by the sender;
receiving from the sender data representing a message that the sender wishes to send and data representing the sender's selection of said different target profile elements and their combination for that particular message to define a target profile that is specific to that particular message; and
supplying the message and the target profile specific to that message to the intermediate communication apparatus.

22. A method according to claim 20 or claim 21, further comprising the steps performed by the communication apparatus in any one of claims 2 to 17.

23. A method of operating a communications system, the method comprising the following steps:
a first communication apparatus of a first user transmits first location data, related to the location of the first user, to an intermediate communication apparatus;
the intermediate communication apparatus converts the first location data into first coordinates;
a second communication apparatus of a second user transmits second location data, related to the location of the second user, to the intermediate communication apparatus;
the intermediate communication apparatus converts the second location data into second coordinates;
the first communication apparatus transmits to the intermediate communication apparatus a message and preferably also an allocation specification, from which the intermediate communication apparatus can ascertain to which other user or users the message is to be allocated;
the intermediate communication apparatus allocates the message to the second user, for transmission to or retrieval by the second user; and
the intermediate communication apparatus indicates to the second user the relative location of the first user to the second user.

24. A method according to claim 23, wherein the intermediate communication apparatus indicates to the second user the relative location prior to the message being transmitted to or retrieved by the second user, or alternatively provides to the second user the indication of the relative location along with the message when it is transmitted to or retrieved by the second user.

25. A method according to claim 23 or 24, wherein the relative location is indicated by a map provided to the second user and showing thereon the respective locations of the first and second user.

26. A method according to claim 25, wherein the map is selected from plurality of maps according to its scale.

27. A method according to claim 25 or 26, wherein one or more of the plurality of maps locates the second user at its centre.

28. A method according to any one of claims 25 to 27, wherein the relative locations are indicated on the map by icons determined in relation to the subject matter of the message and/or the allocation specification.

29. A method according to any one of claims 25 to 28, wherein one or more of the maps are stored in advance at the second communication apparatus ready for just the location of the first user to be added thereon later to provide the indication.

30. A method according to any one of claims 25 to 29, wherein the intermediate communication apparatus stores one or more maps that are common to a plurality of users.

31. A method according to any one of claims 23 to 30, wherein the second communication apparatus displays the location indication for viewing by the second user.

32. A method performed by an intermediate communication apparatus in a communications system, the method comprising the following steps:
receiving, from a first communication apparatus of a first user, first location data, related to the location of the first user;
converting the first location data into first coordinates;
receiving, from a second communication apparatus of a second user, second location data, related to the location of the second user;
converting the second location data into second coordinates;
receiving from the first user a message and preferably also an allocation specification from which the intermediate communication apparatus can ascertain to which other user or users the message is to be allocated;
allocating the message to the second user, for transmission to or retrieval by the second user; and
indicating to the second user the relative location of the first user to the second user.

33. A method according to claim 32, further comprising the steps performed by the intermediate communication apparatus in any one of claims 24 to 31.

34. A method performed by a communication apparatus of a user in a communications system, the method comprising the following steps:
transmitting location data, related to the location of the user, to an intermediate communication apparatus;
receiving or retrieving a message sent from a further user to the intermediate communication apparatus and allocated to the user; and
receiving or retrieving from the intermediate communication apparatus an indication of the relative location of the further user to the user.

35. A method according to claim 34, further comprising the steps performed by the second communication apparatus in any one of claims 24 to 31.

36. A method performed by an intermediate communication apparatus in a communications system, the method comprising the following steps:
receiving a plurality of messages and allocation specifications from a plurality of users;
storing the plurality of messages;
specifying a respective message ID for each message;
determining from the allocation specification which users are to be allocated as recipient users to receive respective messages;
forming for each recipient user a users list of the message ID's of the messages allocated to that recipient user; and
making the message available for transmission to or retrieval by a recipient user on the basis of the message ID so that the intermediate communication apparatus need only store one copy of the message.

37. A method of operating a communications system, the method comprising the following steps:
a communication apparatus of a first user transmits data, relating to the first user, to an intermediate communication apparatus;
the intermediate communication apparatus stores the data relating to the first user;
a communication apparatus of a second user transmits folder data to the intermediate communication apparatus, wherein the folder data defines folder identities, a folder structure and folder allocation rules for allocating messages to folders;
the first communication apparatus transmits to the intermediate communication apparatus a message and preferably also an allocation specification from which the intermediate communication apparatus can ascertain to which other user or users the message is to be allocated;
the intermediate communication apparatus allocates the message to the second user;
the intermediate communication apparatus analyses the folder allocation rules with respect to the data relating to the first user and/or with respect to the allocation specification; and
responsive to the analysis, the intermediate communication apparatus specifies one or more folder identities of the second user for transmission to or retrieval by the second user of the message directly into the one or more specified folder identities.

38. A method performed by an intermediate communication apparatus in a communications system, the method comprising the following steps:
receiving, from a communication apparatus of a first user, data relating to the first user;
storing the data relating to the first user;
receiving, from a communication apparatus of a second user, folder data, wherein the folder data defines folder identities, a folder structure and folder allocation rules for allocating messages to folders;
receiving from the first user a message and preferably also an allocation specification from which the intermediate communication apparatus can ascertain to which other user or users the message is to be allocated;
allocating the message to the second user;
analysing the folder allocation rules of the second user with respect to the data relating to the first user and/or with respect to the allocation specification;
and, responsive to the analysis, specifying one or more folder identities of the second user for transmission to or retrieval by the second user of the message directly into the one or more specified folder identities.

39. A method according to claim 37 or 38, wherein the data relating to the first user is the user profile according to any one of claims 1 to 22.

40. A method performed by a communication apparatus of a user in a communications system, the method comprising the following steps:
providing, to an intermediate communication apparatus, folder data, wherein the folder data defines folder identities, a folder structure and folder allocation rules for allocating messages to folders; and
receiving or retrieving from the intermediate communication apparatus a message directly into one or more folder identities.

41. A method of operating a communications system, the method comprising the following steps:
a first communication apparatus of a first user provides a user profile to an intermediate communication apparatus, wherein the user profile specifies characteristics related to the first user;
the first communication apparatus transmits to the intermediate communication apparatus a message, preferably also an allocation specification from which the intermediate communication apparatus can ascertain to which other user or users the message is to be allocated, and an indication of a selection of the characteristics specified in the user profile;
the intermediate communication apparatus allocates the message to a second user, for transmission to or retrieval by the second user; and
the intermediate communication apparatus indicates to the second user the characteristics contained in the first user's selection of characteristics.

42. A method according to claim 41, wherein the intermediate communication apparatus indicates the characteristics to the second user prior to the message being transmitted to or retrieved by the second user, or alternatively provides the indication of the characteristics to the second user along with the message when it is transmitted to or retrieved by the second user.

43. A method performed by an intermediate communication apparatus in a communications system, the method comprising the following steps:
receiving from a first communication apparatus of a first user a user profile, wherein the user profile specifies characteristics related to the first user;
receiving from the first communication apparatus a message, preferably also an allocation specification from which the intermediate communication apparatus can ascertain to which other user or users the message is to be allocated, and an indication of a selection of the characteristics specified in the user profile;
allocating the message to the second user, for transmission to or retrieval by the second user; and
indicating to the second user the characteristics contained in the first user's selection of characteristics.

44. A method performed by a communication apparatus of a user in a communications system, the method comprising the following steps:
providing a user profile to an intermediate communication apparatus, wherein the user profile specifies characteristics related to the user; and
transmitting to the user a message, preferably also an allocation specification, from which the intermediate communication apparatus can ascertain to which other user or users the message is to be allocated, and an indication of a selection of the characteristics specified in the user profile.

45. A method according to any one of claims 23 to 44, wherein the allocation specification is the target profile according to any one of claims 1 to 22.

46. A method according to any one of claims 1 to 45, wherein the user profile elements or characteristics are specified in the user profile in one or more hierarchical structures; and
the specification of target profile elements or criteria and/or the selection of the characteristics comprises specification or selection in terms of one or more hierarchical levels of the one or more hierarchical structures.

47. A method comprising a combination of the methods according to any or more preceding claims when such combination is not already claimed.

48. A communications system comprising an intermediate communication apparatus and respective communication apparatus means for performing the steps of any one of claims 1 to 17, 23 to 31, 37, 39, 41, 42 and 45 to 47.

49. An intermediate communication apparatus comprising means for performing the steps of any one of claims 18, 19, 32, 33, 36, 38, 39, 43 and 45 to 47.

50. A communication apparatus comprising means for performing the steps of any one of claims 20 to 22, 34, 35, 40 and 44 to 47.

51. A communication apparatus for enabling communication of messages from one or more recipient communication apparatus via a communication service provided by an intermediate communication apparatus, which communication apparatus comprises:
enabling means for enabling a sender to select any combination of a plurality of different target profile elements to enable the sender to define, at the time of sending a message, a recipient target profile consisting of a combination of different target profile elements selected by the sender, so allowing the sender to define different target profiles for different messages to enable the sender to target a specific message to a specific recipient audience desired by the sender;
receiving means for receiving from the sender data representing a message that the sender wishes to send and data representing the sender's selection of said different target profile elements and their combination for that particular message to define a target profile that is specific to that particular message; and
communicating means for communicating the message and the target profile specific to that message to the intermediate communication apparatus.

52. A communication apparatus for enabling communication of messages from a sender communication apparatus to one or more recipient communication apparatus, the communication apparatus comprising:
receiving means for receiving messages each with an accompanying target profile specific to that message and containing a combination of target profile elements,
accessing means for, in response to receipt of each message, accessing a database containing, for each user of the communication service provided by the intermediate communication apparatus, a user profile having a plurality of user profile elements each containing data representing information related to the corresponding user for that user profile element,
comparing means for comparing the target profile accompanying the received message with each of the accessed user profiles to determine whether any user profile contains a combination of user profile elements that matches the combination of target profile elements in the target profile accompanying the message, and
identifying means for identifying as a recipient for the received message any user having a user profile which contains a combination of user profile elements that matches the combination of target profile elements in the target profile accompanying the received message.

53. A storage medium storing processor-implementable instructions for controlling one or more processors to carry out the method of any one of claims 1 to 47.

54. A signal carrying processor-implementable instructions for controlling one or more processors to carry out the method of any one of claims 1 to 47.

55. A method of enabling communication of messages from a sender communication apparatus to one or more recipient communication apparatus via a communication service provided by an intermediate communication apparatus, which method comprises:
at the sender communication apparatus, for each message that a sender wishes to send:
enabling the sender to select any combination of a plurality of different target profile elements to enable the sender to define, at the time of sending a message, a recipient target profile including a combination of different target profile elements selected by the sender, so allowing the sender to define different target profiles for different messages to enable the sender to target a specific message to a specific recipient audience desired by the sender;
receiving from the sender data representing a message that the sender wishes to send and data representing the sender's selection of said different target profile elements and their combination for that particular message to define a target profile that is specific to that particular message; and
communicating the message and the target profile specific to that message to the intermediate communication apparatus; and
at the intermediate communication apparatus, receiving messages each with the accompanying target profile specific to that message and, in response to receipt of each message,
accessing a database containing, for each user of the communication service provided by the intermediate communication apparatus, a user profile having a plurality of user profile elements each containing data representing information related to the corresponding user for that user profile element,
comparing the target profile accompanying the received message with each of the accessed user profiles to determine whether any user profile contains a combination of user profile elements that matches the combination of target profile elements in the target profile accompanying the message, and
identifying as a recipient for the received message any user having a user profile which contains a combination of user profile elements that matches the combination of target profile elements in the target profile accompanying the received message.

56. A method according to claim 55, wherein the steps carried out at the intermediate communication apparatus further include sending the message to the communication apparatus of the or each identified user.

57. A method according to claim 55, wherein identifying as a recipient at the intermediate communication apparatus includes identifying recipients solely on the basis of the target profile accompanying the received message.

58. A method according to claim 55, wherein enabling the sender at the sender communication apparatus includes displaying to the sender on a display of the sender communication apparatus at least one target profile element input screen.

59. A method according to claim 55, wherein enabling a sender to select target profile elements at the sender communication apparatus includes displaying to the sender on a display of the sender communication apparatus at least one display screen displaying different target profile elements selectable by the sender.

60. A method according to claim 55, wherein enabling a sender to select target profile elements at the sender communication apparatus includes enabling the sender to specify input target profile elements related to at least one of: personal interests, professional interests, location, current location, office, department, project membership, group membership, qualifications, skills, job function, job title/position, gender, age, years service, required of a recipient for the message that the sender wishes to send.

61. A method according to claim 55, wherein enabling a sender includes enabling the sender to select target profile elements as alternatives as well as in combination.

62. A method according to claim 55, wherein the enabling step includes enabling the sender to select target profile elements combined by both logical AND and logical OR operations.

63. A method according to claim 55, further comprising at the intermediate communication apparatus indicating the number of recipient users to the recipient users.

64. A method according to claim 55, wherein after the intermediate communication apparatus performs the comparing step, indicating to the sender communication apparatus the current number of matches between the target profile and the user profiles.

65. A method according to claim 64, wherein after indicating the current number of matches, the sender communication apparatus transmits a revised target profile to the intermediate communication apparatus, and this is repeated until the revised target profile is specified by the user to be a final target profile; and the message is communicated to the intermediate communication apparatus after the revised target profile is specified by the user to be the final target profile.

66. A method according to claim 55, wherein the target profile further specifies a required number of recipients and the one or more target profile elements comprises a plurality of criteria in an order or priority;
wherein the comparing step comprises repeatedly comparing the criteria of the target profile in order of priority of the criteria with the user profiles until the number of user profiles which match the target profile to the extent of the criteria so far compared first falls below, or alternatively lies closest to, the specified required number of recipients; and
wherein the identifying step comprises allocating the message to those users whose user profiles are in the number of user profiles which first falls below or alternatively lies closest to the specified required number of recipients.

67. A method according to claim 55, wherein the user profiles comprise location data specifying the location of the users and the target profile includes a location target profile element specifying a location criteria.

68. A method according to claim 67, wherein the location data is in the form of a place name hierarchy and the comparing step comprises comparing the location data in the user profiles with the location data in the target profile at a hierarchical level specified in the target profile.

69. A method according to claim 67, wherein the location criteria specified in the target profile specifies a required maximum distance between candidate recipient users and a specified location, wherein the specified location is for example the location of the sender transmitting the target profile, and the location data is in the form of an area hierarchy which is used either to pre-filter the number of candidate recipient users for whom a more accurate matching procedure is then performed or to provide an approximate matching procedure for the location criteria.

70. A method according to claim 55, wherein the users of the communication service are divided into a plurality of categories; users in a first category select one or more users in a second category to be associated with, preferably from a shortlist of users in the second category which is provided by the intermediate communication apparatus by comparing target profiles supplied by the users of the second category with the user profiles; and
wherein the intermediate communication apparatus only compares the target profile transmitted with the message with user profiles of those users who are associated with the user who transmitted the target profile and message.

71. A method according to claim 70, wherein the communication apparatus of a user in a second category transmits a message but no target profile, and the intermediate communication apparatus allocates the message to all those users in the first category who are associated with the user who transmitted the message.

72. A method of enabling communication of messages from a sender communication apparatus to one or more recipient communication apparatus via a communication service provided by an intermediate communication apparatus, which method comprises:
at the intermediate communication apparatus, receiving messages each with an accompanying target profile specific to that message and containing a combination of target profile elements and, in response to receipt of each message,
accessing a database containing, for each user of the communication service provided by the intermediate communication apparatus, a user profile having a plurality of user profile elements each containing data representing information related to the corresponding user for that user profile element,
comparing the target profile accompanying the received message with each of the accessed user profiles to determine whether any user profile contains a combination of user profile elements that matches the combination of target profile elements in the target profile accompanying the message, and
identifying as a recipient for the received message any user having a user profile which contains a combination of user profile elements that matches the combination of target profile elements in the target profile accompanying the received message.

73. A method according to claim 72, wherein the steps carried out at the intermediate communication apparatus further include sending the message to the communication apparatus of the or each identified user.

74. A communications system, comprising:
a first communication apparatus of a first user transmits first location data, related to the location of the first user, to an intermediate communication apparatus;
the intermediate communication apparatus converts the first location data into first coordinates;
a second communication apparatus of a second user transmits second location data, related to the location of the second user, to the intermediate communication apparatus;
the intermediate communication apparatus converts the second location data into second coordinates;
the first communication apparatus transmits to the intermediate communication apparatus a message and preferably also an allocation specification, from which the intermediate communication apparatus can ascertain to which other user or users the message is to be allocated;
the intermediate communication apparatus allocates the message to the second user, for transmission to or retrieval by the second user; and
the intermediate communication apparatus indicates to the second user the relative location of the first user to the second user.

75. A system according to claim 74, wherein the intermediate communication apparatus indicates to the second user the relative location prior to the message being transmitted to or retrieved by the second user, or alternatively provides to the second user the indication of the relative location along with the message when it is transmitted to or retrieved by the second user.

76. A system according to claim 74, wherein the allocation specification includes a recipient target profile including a combination of different target profile elements selected by the sender, so allowing the sender to define different target profiles for different messages to enable the sender to target.

77. A system according to claim 74, wherein the relative location is indicated by a map provided to the second user and showing thereon the respective locations of the first and second user.

78. A system according to claim 77, wherein the map is selected from plurality of maps according to its scale.

79. A system according to claim 77, wherein one or more of the plurality of maps locates the second user at its centre.

80. A system according to claim 77, wherein the relative locations are indicated on the map by icons determined in relation to the subject matter of the message and/or the allocation specification.

81. A system according to claim 77, wherein one or more of the maps are stored in advance at the second communication apparatus ready for just the location of the first user to be added thereon later to provide the indication.

82. A system according to claim 77, wherein the intermediate communication apparatus stores one or more maps that are common to a plurality of users.

83. A system according to claim 77, wherein the second communication apparatus displays the location indication for viewing by the second user.

84. A method performed by an intermediate communication apparatus in a communications system, the method comprising:
receiving a plurality of messages and allocation specifications from a plurality of users;
storing the plurality of messages;
specifying a respective message ID for each message;
determining from the allocation specification which users are to be allocated as recipient users to receive respective messages;
forming for each recipient user a users list of the message ID's of the messages allocated to that recipient user; and
making the message available for transmission to or retrieval by a recipient user on the basis of the message ID so that the intermediate communication apparatus need only store one copy of the message.

85. A communications system, comprising:
an intermediate communication apparatus stores data relating to the first user;
a communication apparatus of a first user transmits data, relating to the first user, to the intermediate communication apparatus;
a communication apparatus of a second user transmits folder data to the intermediate communication apparatus, wherein the folder data defines folder identities, a folder structure and folder allocation rules for allocating messages to folders;
the first communication apparatus transmits to the intermediate communication apparatus a message and preferably also an allocation specification from which the intermediate communication apparatus can ascertain to which other user or users the message is to be allocated;
the intermediate communication apparatus allocates the message to the second user;
the intermediate communication apparatus analyses the folder allocation rules with respect to the data relating to the first user and/or with respect to the allocation specification; and
responsive to the analysis, the intermediate communication apparatus specifies one or more folder identities of the second user for transmission to or retrieval by the second user of the message directly into the one or more specified folder identities.

86. A method performed by a communication apparatus of a user in a communications system, the method comprising:
providing, to an intermediate communication apparatus, folder data, wherein the folder data defines folder identities, a folder structure and folder allocation rules for allocating messages to folders; and
receiving or retrieving from the intermediate communication apparatus a message directly into one or more folder identities.

87. A communications system, comprising:
a first communication apparatus of a first user provides a user profile to an intermediate communication apparatus, wherein the user profile specifies characteristics related to the first user;
the first communication apparatus transmits to the intermediate communication apparatus a message, preferably also an allocation specification from which the intermediate communication apparatus can ascertain to which other user or users the message is to be allocated, and an indication of a selection of the characteristics specified in the user profile;
the intermediate communication apparatus allocates the message to a second user, for transmission to or retrieval by the second user; and
the intermediate communication apparatus indicates to the second user the characteristics contained in the first user's selection of characteristics.

88. A system according to claim 87, wherein the intermediate communication apparatus indicates the characteristics to the second user prior to the message being transmitted to or retrieved by the second user, or alternatively provides the indication of the characteristics to the second user along with the message when it is transmitted to or retrieved by the second user.

89. A method according to any one of claims 54, 73, 84, and 86, wherein the user profile elements or characteristics are specified in the user profile in one or more hierarchical structures; and
the specification of target profile elements or criteria and/or the selection of the characteristics comprises specification or selection in terms of one or more hierarchical levels of the one or more hierarchical structures.

90. A communications system for enabling communication of messages between of a group of users of the system, the communications system comprising: a plurality of user computing apparatus each associated with a different user in the group and communications apparatus for enabling communication of messages between the user computing apparatus,
the communications apparatus having:
user profile data providing means providing user profile data comprising characteristic data representing characteristics that can be associated with a user; and
personal user profile storing means storing, for each user, a personal user profile comprising personal profile data comprising characteristic data selected from the user profile data for that user, each user computing apparatus having:
message sending means for sending messages;
message receiving means for receiving messages; and message generating means for enabling the associated user to generate a message for one or more other users in the group, the message generating means comprising
message content receiving means for receiving message content data from the associated user, target profile data selecting means for enabling the associated user to select from the user profile data characteristic data representing characteristics that the associated user requires be associated with the recipient or recipients of the message, and
target profile data generating means for generating for the message a target profile comprising target profile data representing the characteristic data selected by the associated user,
the communications apparatus also having:
comparing means for comparing the message target profile data with the personal user profile data stored by the personal user profile storing means to identify as recipient or recipients of the message any user or users in the group having personal user profiles that match the target profile; and
message communicating means for enabling the message content data to be communicated to the message receiving means of the user computing apparatus associated with the identified recipient or recipients.
